(19) United States
(12) Patent Application Publication
(10) Pub. No.: US 2019/0057788 A1
(43) Pub. Date: Feb. 21, 2019

(54) JET PUMP PLUG SEAL AND METHODS OF MAKING AND USING SAME

(71) Applicant: EXELON GENERATION COMPANY, LLC, Kennett Square, PA (US)

(72) Inventors: Nicholas P. Osmond, Plainfield, IL (US); Vikram Shah, Plainfield, IL (US)

(21) Appl. No.: 15/884,072

(22) Filed: Jan. 30, 2018

Related U.S. Application Data
(60) Provisional application No. 62/452,027, filed on Jan. 30, 2017.

(51) Int. Cl. G21C 19/04; F16L 55/11; F16L 55/10

(52) U.S. Cl. CPC G21C 19/04; F16L 55/1011; F16L 55/11

(57) ABSTRACT

A jet pump plug and methods of forming a seal with a plurality of nozzles of a jet pump are disclosed. The plug has a plug body and a washer embedded within and bonded to the plug body. The washer has a center opening that cooperates with the plug body to define a central bore extending through the plug and the central bore can be configured to receive a fastener. A plurality of the disclosed plugs can be positioned in alignment with a respective nozzle, with each plug being sealed to the respective nozzle to form a seal.

### CROSS-REFERENCE TO RELATED APPLICATIONS

This application claims priority to U.S. Provisional Application No. 62/452,027, filed Jan. 30, 2017. The disclosure of the above-referenced application is hereby incorporated herein by reference in its entirety.

### FIELD

The present disclosure relates in general to jet pumps and, in particular, to improved plug seals for sealing the nozzles of a multi-nozzle jet pump.

### BACKGROUND

Jet pumps are employed in many different industrial applications, including the circulation of cooling water in a boiling water reactor. In such an application, external water pumps are used to develop a high velocity water stream which is delivered by feed pipes to the jet pumps located within the reactor shell. The nozzles of each jet pump discharge into the throat of a mixer pipe or the like in which the streams of cooling water are intermixed with the heated water present, driving the mixture out through the bottom of the jet pump diffuser and tail pipe.

On occasion, it is necessary to stop the water circulation to the jet pump in order to open and repair portions of the external circulation piping. In order to prevent reactor water from flowing back through the submerged jet pump nozzles and out of the reactor shell, some arrangement is required for positively closing off the pump nozzles in the interior of the reactor.

The problem described above also exists in early jet pump models; however, such pumps generally have only a single nozzle. As the jet pump art has developed further, single nozzle jet pumps have been joined by multi-nozzle pumps, for example employing a cluster of five nozzles.

In a boiling water nuclear reactor, a reactor vessel has to be flooded to a level above the nozzles. Since the nozzles and reactor coolant loop piping are not isolated, work on other loop components (e.g., reactor coolant pumps) is precluded during maintenance and inspection. In order to work on other loop components, reactor vessel nozzle plugs can be used to isolate the reactor from the rest of the system. However, during operations, such as jet pump plug manipulation and/or removal, there remains a likelihood of the plug, or seal, being pulled off the jet pump plug fixture and sucked into the nozzle due to the negative relative pressure created by the head of the flooded up volume of the water and the draining of the reactor system. Due to the physical size of conventional plugs, a peripheral fuel orifice can become blocked by the plugs after the plugs are detached from the jet pump plug tooling. Further, while the material used in conventional plugs may allow the plug to become flexible enough to pass through the orifice, the plug can then be captured inside the fuel cell filters. The foregoing problems cause the vessel to become clogged, thereby causing degradation and/or failure of the system.

Accordingly, there is still a need for jet pump plugs that are capable of at least partially addressing one or more of the issues, defects, or disadvantages associated with conventional plugs.

### SUMMARY

Described herein, in various aspects, is a plug comprising: a plug body defining a central bore and comprising a polyurethane ester; and a washer embedded within and bonded to the plug body, wherein the washer has a center opening. In these aspects, the center opening of the washer cooperates with the central bore of the plug body to define a passageway extending through the plug. In further aspects, the passageway can be configured to receive a fastener. Also described herein are methods of making the disclosed plug.

Further described herein, in various aspects, is a method of forming a seal with a plurality of nozzles of a jet pump, comprising: positioning a plurality of plugs as disclosed herein in alignment with the plurality of nozzles of the jet pump, wherein each plug is positioned in alignment with a respective nozzle; and securing each plug to a respective nozzle to form a seal over the nozzle.

Additional aspects of the invention will be set forth, in part, in the detailed description, and claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

FIGS. 1A-1B are top (FIG. 1B) and bottom (FIG. 1A) views of exemplary plugs as disclosed herein.

FIG. 2 depicts a top view of an exemplary washer as disclosed herein.

FIGS. 3A-3B depicts top (FIG. 3A) and side (FIG. 3B) views of another exemplary washer as disclosed herein.

FIGS. 4A-4B depicts top (FIG. 4A) and side (FIG. 4B) views of another exemplary washer as disclosed herein.

FIG. 5 depicts results obtained for 160° F. Durability Test.

FIGS. 6A-6F depict the photographs of exemplary fixtures after 160° F. Nozzle Penetration and Leak Check Test of the following materials: Ester based Polyurethane (PUR) (FIGS. 6A and 6D); Natural Rubber with Carbon Black, also known as a “Black Natural Rubber” (NR Black) (FIGS. 6B and 6E); and Natural Rubber without Carbon Black, also known as a “White Natural Rubber” (NR White) (FIGS. 6C and 6F). FIGS. 6A-6C show no leaking and FIGS. 6D-6F show no visible damage, was observed.

FIG. 7 depicts results obtained for 140° F. Durability Test.

FIGS. 8A-8F depict the photographs of exemplary fixtures after 140° F. Nozzle Penetration and Leak Check Test of Ester PUR (FIGS. 8A and 8D); NR Black (FIGS. 8B and 8E); and NR White (FIGS. 8C and 8F). FIGS. 8A-8C show no leaking and FIGS. 8D-8F show no visible damage, was observed.

FIG. 9 depicts results obtained for 110° F. Stability Test.

FIGS. 10A-10F depict the photographs of exemplary fixtures after 110° F. Nozzle Penetration and Leak Check Test of Ester PUR (FIGS. 10A and 10D); NR Black (FIGS. 10B and 10E); and NR White (FIGS. 10C and 10F). FIGS. 10A-10C show no leaking and FIGS. 10D-10F show no visible damage, was observed.

FIG. 11 depicts results obtained for 160° F.-200° F. Extended Durability Test

FIG. 12 depicts results of high temperature testing (170° F., 180° F., and 190° F. Durability Test).

FIG. 13 depicts dimensional changes of exemplary materials at 160° F., 140° F., 110° F., and extended 160° F.-212° F. testing.

FIG. 14 depicts dimensional changes of exemplary materials at 170° F., 180° F., and 190° F.

FIG. 15 depicts results from compression set testing of exemplary materials at 160° F., 140° F., and 110° F.

FIG. 16 depicts water adsorption (in weight, % change) of exemplary materials at 160° F., 140° F., 110° F., and extended 160° F.-212° F. testing.

FIG. 17 depicts water adsorption (in weight, % change) of exemplary materials at 170° F., 180° F., and 190° F.

FIGS. 18A, 18B, and 18C respectively depict photographs of exemplary fixtures after 170° F., 180° F., and 190° F. durability test: compression and tear details.

FIG. 19 is a partially transparent perspective view depicting a washer embedded within a plug body as disclosed herein.

FIGS. 20A-20B are first and second portions of a mold assembly for forming a plug as disclosed herein.

FIG. 21 depicts an exemplary boiling water reactor having a jet pump positioned within the reactor as disclosed herein.

FIG. 22 depicts an exemplary jet pump having a plurality of nozzles as disclosed herein.

FIG. 23 depicts another exemplary jet pump as disclosed herein.

FIG. 24 depicts an exemplary jet pump having a plurality of nozzles as disclosed herein.

FIG. 25 depicts an exemplary plug secured to a nozzle with a fastener as disclosed herein.

### DETAILED DESCRIPTION

The present invention can be understood more readily by reference to the following detailed description, examples, drawings, and claims, and their previous and following description. However, before the present compositions, articles, devices, systems, and/or methods are disclosed and described, it is to be understood that this invention is not limited to the specific compositions, articles, devices, systems, and/or methods disclosed unless otherwise specified, as such can, of course, vary. It is also to be understood that the terminology used herein is for the purpose of describing particular aspects only and is not intended to be limiting.

The following description of the invention is also provided as an enabling teaching of the invention in its best, currently known aspect. To this end, those of ordinary skill in the relevant art will recognize and appreciate that changes and modifications can be made to the various aspects of the invention described herein, while still obtaining the beneficial results of the present invention. It will also be apparent that some of the desired benefits of the present invention can be obtained by selecting some of the features of the present invention without utilizing other features. Accordingly, those of ordinary skill in the relevant art will recognize that many modifications and adaptations to the present invention are possible and can even be desirable in certain circumstances and are thus also a part of the present invention. Thus, the following description is provided as illustrative of the principles of the present invention and not in limitation thereof.

Various combinations of elements of this disclosure are encompassed by this invention, e.g. combinations of elements from dependent claims that depend upon the same independent claim.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

It is also to be understood that the terminology used herein is for the purpose of describing particular aspects only and is not intended to be limiting. As used in the specification and in the claims, the term “comprising” may include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used herein, the singular forms “a,” “an” and “the” include plural referents unless the context clearly dictates otherwise. Thus, for example, reference to a “plug” includes aspects having two or more plugs unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” mean that the subsequently described event or circumstance may or may not occur, and that the description includes instances where said event or circumstance occurs and instances where it does not.

The word “or” as used herein means any one member of a particular list and also includes any combination of members of that list.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

The following description supplies specific details in order to provide a thorough understanding. Nevertheless, the skilled artisan would understand that the present compositions, articles, devices, systems, and/or methods can be implemented and used without employing these specific details. Indeed, the apparatus and associated methods can be placed into practice by modifying the illustrated apparatus and associated methods and can be used in conjunction with any other apparatus and techniques conventionally used in the industry.

The present invention may be understood more readily by reference to the following detailed description of various aspects of the invention and the examples included therein and to the Figures and their previous and following description.

### Overview

Jet pump plugs are maintenance tools which are used to isolate reactor recirculation discharge from a reactor cavity when a reactor unit is shutdown or defueled. During refueling outages, conventional jet pump plug seals can become detached from the tooling and potentially enter the reactor vessel. When this happens, the detached seals can potentially block the majority of a peripheral fuel support piece orifice, the smallest of the orifices, and cause significant flow restrictions that would violate fuel safety limits at a higher power level. Conventional jet pump plug materials will not melt or breakdown in reactor conditions, and even if the detached plug seals soften such that they can pass through a peripheral orifice, the plug seals will become trapped in debris filters, causing downstream flow blockages.

It is contemplated that the plugs disclosed herein can be configured to address one or more of these issues by minimizing the consequences of a detached seal and minimizing the potential for a seal to become detached. As further disclosed herein, the minimization of the consequences of a detached seal can be attained by using plug materials that meet the performance requirements of a refueling outage, while holding the ability to dissolve and dissipate into the reactor coolant volume during startup if lost, thereby eliminating the concerns of flow blockage and any impacts on startup or normal operations. The plug materials disclosed herein can be designed to completely melt, ensuring the fuel integrity is maintained during startup. As further disclosed herein, the selected plug materials were tested for chemical leachability, chemical dispersion upon melting, conductivity, seal retention, nozzle penetration, compression set, dimensional, and sealability. In contrast to conventional materials, which have usage limitations based on maximum or minimum temperature ratings, the temperature limitations of the materials disclosed herein can be used advantageously to ensure complete melting.

As further disclosed herein, the minimization of the potential for detachment of the plugs can be attained using a thin metal disk that is embedded within the plug/seal, thereby improving the retention of the plug/seal by the tooling. The manufacturing process disclosed herein can ensure that the metal disk cannot be removed from the material, while also ensuring that after the material melts away, only the thin disk will remain. The thin embedded metal disk can be designed to be small enough to pass through a peripheral flow orifice, eliminating the concerns of flow blockage.

As further disclosed herein, the plug/seal design can eliminate the risk of a flow blockage caused by a detached plug/seal. Elimination of such flow blockages can protect the nuclear fuel by eliminating the potential of a violation of a fuel safety limit during power operation, thereby ensuring that the health and safety of the public and station personnel are maintained.

It is contemplated that the disclosed plugs/seals can provide significant cost savings with respect to avoidance costs associated with lost generation, analysis and testing of systems after detachment of a plug/seal, time and resources spent attempting to retrieve a detached plug/seal, and costs of staffing reactor stations in support of these issues. The disclosed plug/seal design can eliminate the potential for flow blockage, thereby producing cost avoidance benefits during every refueling outage. It is further contemplated that the plug/seal design disclosed herein can be compatible with existing tooling, thereby avoiding the need to develop new tooling.

It is still further contemplated that the disclosed plugs/seals can prevent unnecessary delays in future startups due to flow blockage created by detached plugs/seals, making future startups more productive and efficient than permitted by current designs. It is still further contemplated that the disclosed plugs/seals can be qualified to be safety-related and seismically qualified, meaning that the design is able to maintain the reactor coolant pressure boundary. Significantly, the use of the disclosed plugs/seals can maintain the fuel's integrity while allowing other maintenance and refueling activities to occur simultaneously.

Although exemplary dimensions and shapes of the plugs/seals are provided herein, it is contemplated that the design can be modified as needed to fit any jet pump or in other applications to provide isolation during an outage.

Overall, the disclosed plug/seal design can eliminate the flow blockage created by detached seals while minimizing the probability of seals becoming detached and protecting the fuel's integrity.

### The Plug

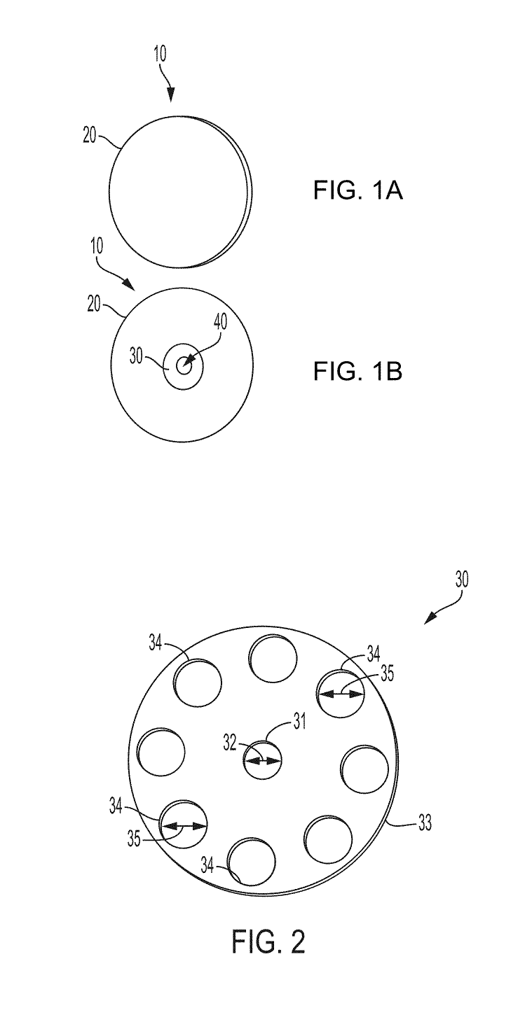

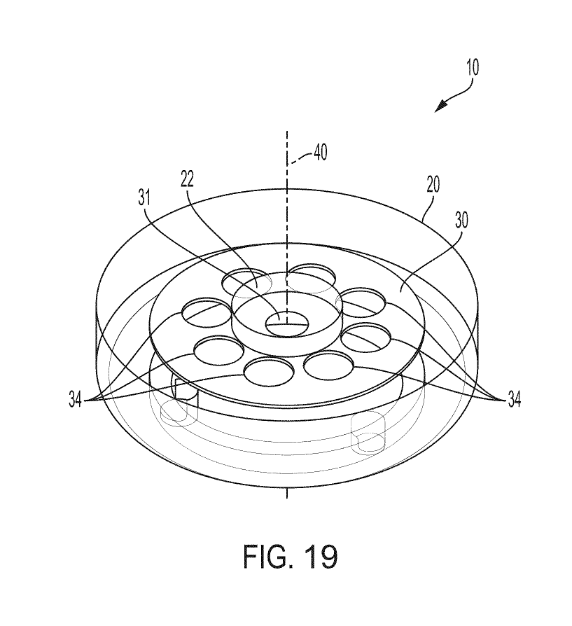

Disclosed herein, in various aspects and with reference to FIGS. 1A-4B and 19, is a plug (or seal) 10, comprising a plug body 20 and a washer 30. In one aspect, the plug body 20 can comprise a composition 21 comprising a polyurethane ester. In an additional aspect, the plug body 20 can define a central bore 22. In another aspect, as shown in FIGS. 1A-1B, the washer 30 can be embedded within and bonded to the plug body 20. In an additional aspect, the washer 30 can have a central opening 31. In a further aspect, the central opening 31 of the washer 30 can cooperate with the central bore 22 of the plug body 20 to define a passageway 40 extending through the plug 10. In still a further aspect, the passageway 40 can be configured to receive a fastener 50. It is contemplated that the fastener 50 can be any conventional fastener used in the industry known to one of skill in the art. For example and without limitation, the fastener 50 can be a screw, a bolt, or the like. Optionally, in exemplary aspects, the central opening 31 of the washer 30 can have a diameter 32 that is less than a diameter 23 of the central bore 22 of the plug body 20 such that the passageway 40 has a variable diameter that decreases within the washer 30. In these aspects, it is contemplated that a portion of the fastener 50 (e.g., the head of a screw) can be configured to abut a portion of the washer 30 that circumferentially surrounds the central opening 31 of the washer and is positioned within the central bore 22 of the plug body 20. Optionally, in further exemplary aspects, it is contemplated that the plug 10 can be a jet pump plug for sealing a multi-nozzle jet pump 60.

In another aspect, the plug body 20 can be configured to melt or break apart when exposed to certain conditions further described herein. For example and without limitation, such conditions can include exposure to temperatures ranging from about 267° F. to about 500° F. In one aspect, it is contemplated that the temperature can be about 500° F. Under such conditions, it is contemplated that the plug body 20 can dissolve into a liquid state or a substantially liquid state. As used herein, the term “substantially liquid state” refers to a plug body 20 that, when exposed to certain conditions such as but not limited to high temperatures, can dissolve to a liquid state comprising some non-cohesive, solid particles or residue. In this aspect, the plug body 20 is not configured to reform after dissolving into a liquid state or a substantially liquid state. In particular, the chemical properties of the polyurethane ester composition 21 disclosed herein are such that, once the plug body 20 dissolves into a liquid state or a substantially liquid state, the plug body will not reform into a solid form, despite any reductions in temperature. Such characteristics of the plug body 20 eliminate the concern that when a dismantled plug or seal 10 is separated from or pulled off a jet pump plug fixture, the plug will be lost inside of a reactor vessel 70 during operations, including without limitation fixture manipulation or removal. Because the disclosed plug body 20 is adapted to melt or dissolve when exposed to high temperatures and cannot reform into a solid state, even if temperatures are reduced, the described concerns of blockage and clogging are eliminated.

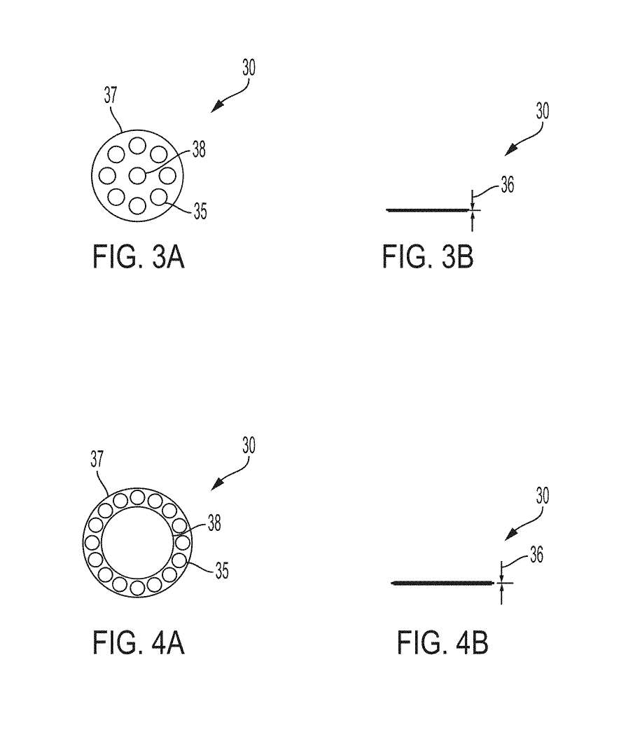

In another aspect, as shown in FIGS. 2-4B, the washer 30 can comprise a metal (e.g., stainless steel) plate 33. In a further aspect, the washer 30 can define a plurality of outer openings 34 that are radially spaced from the central opening 31. In still a further aspect, the plug body 20 can be cured in a position in which portions of the plug body extend through each of the outer openings 34 of the washer 30. In these aspects, each outer opening of the plurality of outer openings 34 of the washer 30 can have a diameter 35 ranging from about 0.1 inches to about 0.25 inches, including exemplary diameters of about 0.13 inches, about 0.15 inches, about 0.17 inches, about 0.19 inches, and about 0.2 inches. Optionally, each of the outer openings 34 can have an equal diameter 35. Although circular openings are depicted in the Figures, it is contemplated that openings having other shapes (e.g., elliptical, oval, square, rectangular, triangular, and other polygonal shapes) can be used. In further aspects, as shown in FIGS. 3B and 4B, the washer 30 can have a thickness 36 ranging from about 0.005 inches to about 0.015 inches, including exemplary thicknesses of about 0.007 inches, about 0.008 inches, about 0.009 inches, about 0.01 inches, about 0.011 inches, about 0.012 inches, about 0.013 inches, and about 0.014 inches. More particularly, in a preferred aspect, the washer 30 can have a thickness 36 of about 0.01 inches. In another aspect, the washer 30 can have an outer diameter 37 ranging from about 1.0 inch to about 1.3 inches, including exemplary diameters of about 1.05 inches, about 1.1 inches, about 1.13 inches, about 1.15 inches, about 1.17 inches, about 1.19 inches, about 1.2 inches, and about 1.25 inches. In another aspect, as shown in FIG. 4A, the washer 30 can have an inner diameter 38 (corresponding to a diameter of the central opening 31) ranging from about 0.6 inches to about 0.9 inches, including exemplary diameters of about 0.65 inches, about 0.7 inches, about 0.75 inches, about 0.8 inches, about 0.85 inches, and most preferably, diameter of about 0.77 inches. In this aspect, it is contemplated that the central opening 31 can be configured to receive a fastener that is complementary to the shape of a center nozzle of a jet pump 60 as is known in the art. In another aspect, as shown in FIG. 3A, the central opening 31 can have a diameter 32 of about 0.1 inches to about 0.3 inches, including exemplary diameters of about 0.15 inches, about 0.2 inches, and about 0.25 inches. In this aspect, it is contemplated that the central opening 31 can be configured to receive a fastener that is complementary to the shape of outer nozzles of a jet pump 60 as is known in the art, which are typically smaller than the center nozzle of the jet pump 60.

In one exemplary aspect, as shown in FIG. 3A, the washer 30 can have an outer diameter 37 ranging from about 1.1 inches to about 1.3 inches and an inner diameter 38 ranging from about 0.6 inches to about 0.9 inches, with the inner diameter 38 of the washer defining the central opening 31. In these aspects, each outer opening of the plurality of outer openings 34 of the washer 30 can have a diameter ranging from about 0.1 inches to about 0.2 inches.

In another exemplary aspect, as shown in FIG. 4A, the washer 30 can have an outer diameter 37 ranging from about 1.05 inches to about 1.2 inches, and the central opening 31 can have a diameter 32 ranging from about 0.15 inches to about 0.25 inches. In this aspect, each outer opening of the plurality of outer openings 34 of the washer 30 can have a diameter 35 ranging from about 0.15 inches to about 0.25 inches.

In use, it is contemplated that the diameters of the washers 30 disclosed herein can be sufficiently small to allow the washer to freely pass through peripheral orifices and other vessels. Thus, even if the plug body 20 becomes detached from the washer 30, the washer will not clog or block the vessels within the reactor.

### Methods of Making the Plug

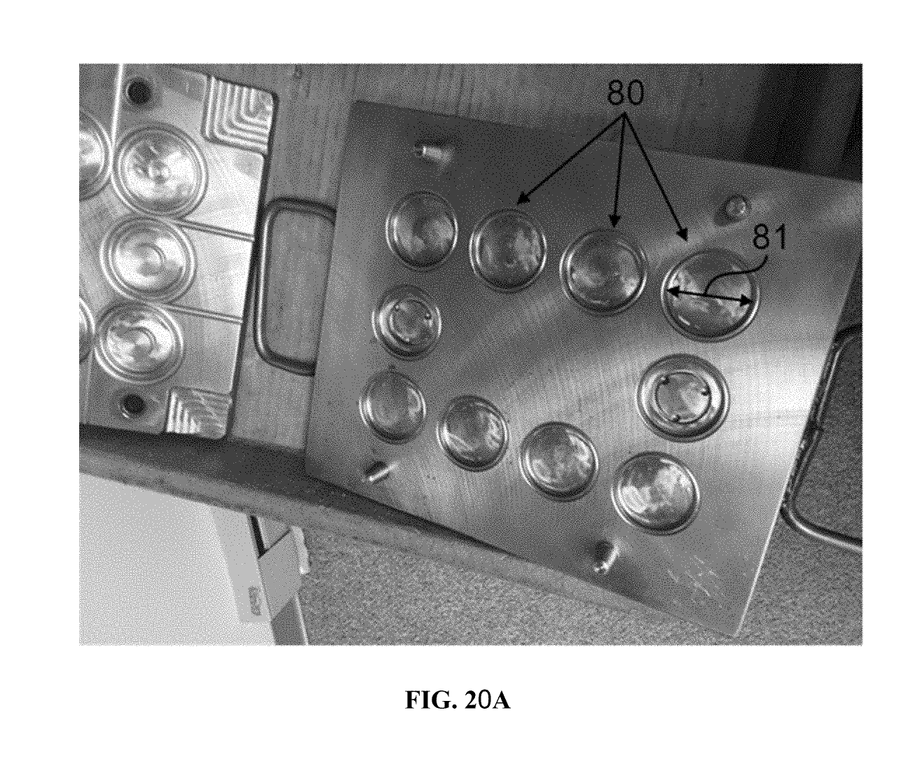

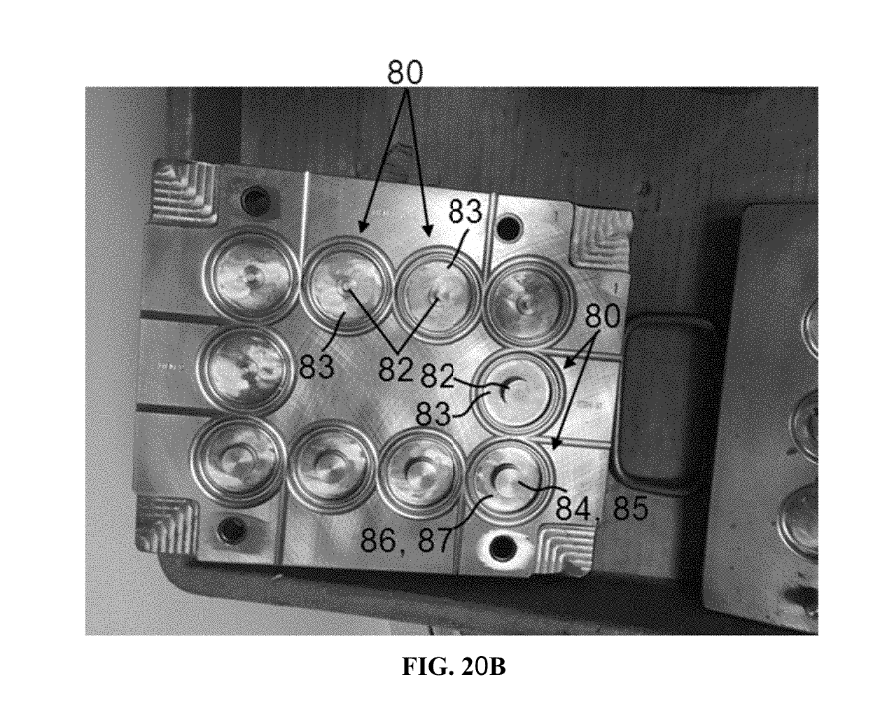

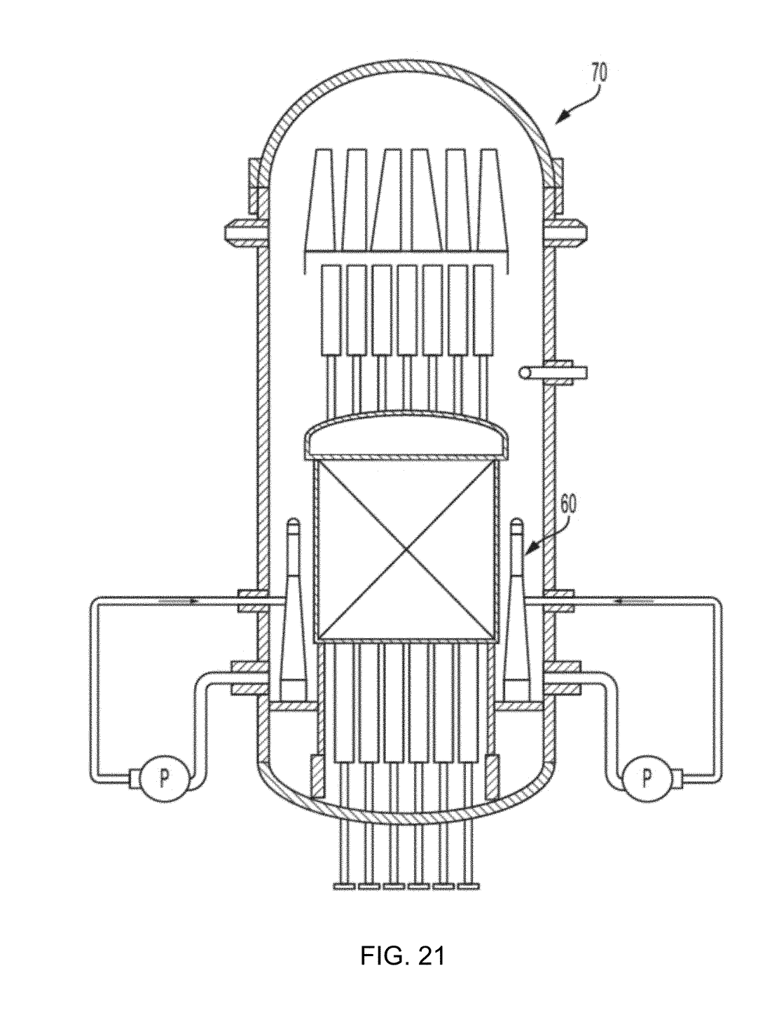

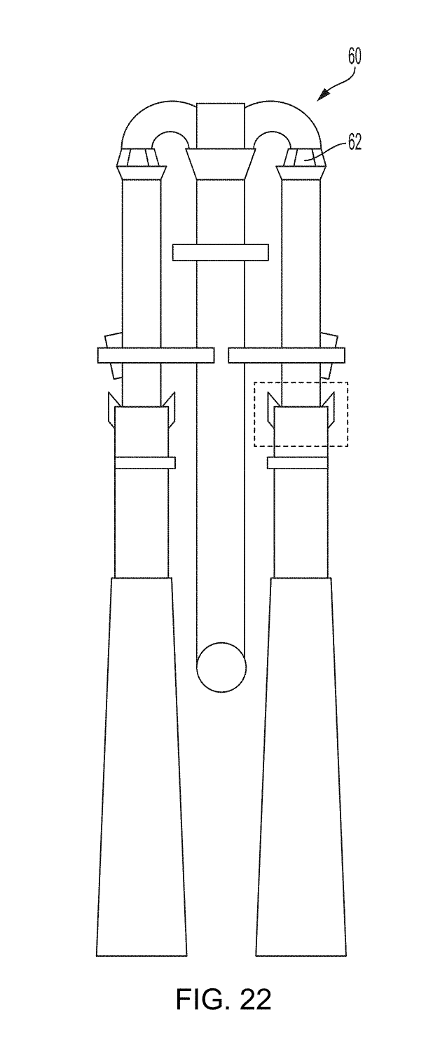

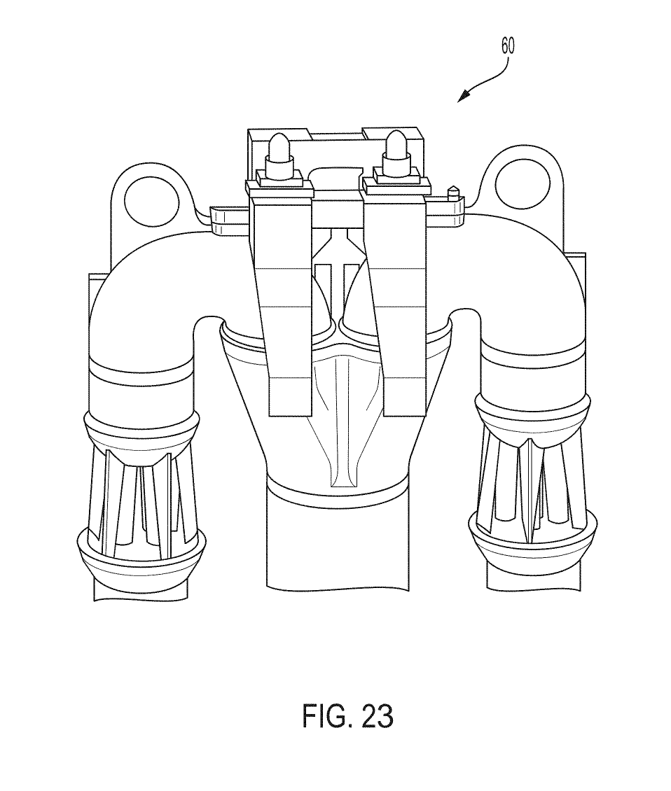

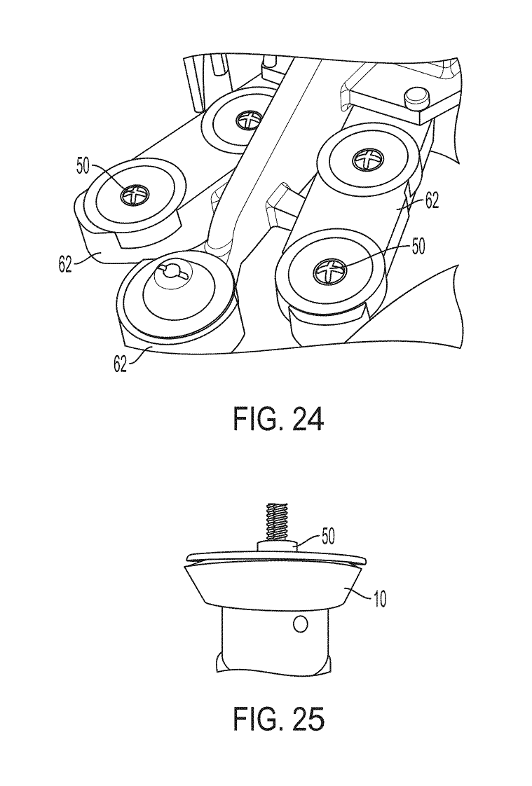

In various aspects, and with reference to FIGS. 20A-20B, methods of making the plug 10 are also disclosed. In one aspect, a method of making the plugs 10 described herein can comprise positioning the washer 30 within a mold 80. In this aspect, the method of making the plugs 10 described herein can further comprise positioning or pouring a liquid material (i.e., the composition) 21 comprising a polyurethane ester within the mold 80, and curing the liquid material 21 to form the plug body 20 with the embedded washer 30. In these aspects, it is contemplated that the washer 30 can have an outer diameter 37 that is less than the inner diameter 81 of the mold 80 so that the liquid material 21 can flow around the outer diameter of the washer 30. It is further contemplated that the liquid material 21 can flow through the plurality of outer openings 34 and around the outer diameter 37 of the washer 30. Optionally, in exemplary aspects, the mold 80 can comprise a center projection 82 and a circumferential receptacle 83 that surrounds the center projection. In these aspects, it is contemplated that the washer 30 can be positioned over (optionally, supported by) a portion of the center projection 82 and rest within the circumferential receptacle 83 until the liquid material 21 is delivered to the circumferential receptacle 83. Optionally, in exemplary aspects, and as shown in FIGS. 20A-20B, each mold 80 can have a first portion 84 and a second portion 86 that define respective upper and lower portions 85, 87 of the mold and can be positioned in alignment to cooperatively form the mold 80 that forms the plug 10 as disclosed herein. Optionally, in these aspects, it is contemplated that either the first portion 84 or the second portion 86 of the mold 80 can define a center projection 82 that supports the washer 30, while both the first portion 84 and the second portion 86 of the mold 80 can define a portion of the circumferential receptacle 83. Alternatively, it is contemplated that both the first portion 84 and the second portion 86 of the mold 80 can define respective portions of the center projection 82 and the circumferential receptacle 83 of the mold 80. In further exemplary aspects, it is contemplated that the diameter and other dimensions of the center projection 82 of the mold 80 can be configured to define corresponding dimensions of the central bore 22 of the plug body 20 (or the passageway 40 of the plug 10). For example, the dimensions of the center projection 82 of the mold 80 can determine whether a plug is shaped to engage a center nozzle or an outer nozzle. In exemplary aspects, a plurality of molds 80 can be produced using an array of first mold portions 84 and an array of second mold portions 86, with the arrays being connectable in alignment (optionally, using mechanical engagement) to form a plurality of molds 80.

As the liquid material 21 cures, it is contemplated that the washer 30 can become embedded within the liquid material 21, thereby forming the plug 10. In these aspects, the washer 30 disclosed herein can offer an increased level of rigidity to the plug body 20 to reduce the possibility of the plug 10 becoming detached from a jet pump 60 after the plug is secured to a nozzle 62 of the jet pump 60. However, in the event that the plug 10 does become detached from the jet pump 60, then it is contemplated that the disclosed plug can have an outer diameter that is small enough that it will not clog the orifice of a jet pump.

In use, it is contemplated that the disclosed plug 10 can form a seal with a plurality of nozzles 62 of a jet pump 60. In one aspect, a plurality of disclosed plugs 10 can be positioned in alignment with the plurality of nozzles 62 of the jet pump 60 such that each plug is positioned in alignment with a respective nozzle, and each plug can be secured to a respective nozzle to form a seal over the nozzle. It is contemplated that the jet pump 60 can be positioned within any boiling water reactor 70 known to those skilled in the art. It is further contemplated that the boiling water reactor 70 can be a nuclear reactor.

In various aspects, it is contemplated that the disclosed plugs, compositions, and methods can offer advantages such as providing plugs with improved sealing capabilities, as well as improved resistance to dissociation from a jet pump. Further advantages can include, without limitation, plugs with materials exhibiting improved chemical properties to prevent clogging, degradation, or system failure caused by a dismantled plug that is lodged inside of a vessel.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for.

There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

### Example 1

To replace EPDM rubber currently used in the Jet Pump Plug seals the following materials were tested: a) Ester based Polyurethane (PUR) from Harkness Industries (two sides of the plug were tested: Side A and Side B); b) Natural Rubber with Carbon Black, also known as a “Black Natural Rubber” (NR Black); and c) Natural Rubber without Carbon Black, also known as a “White Natural Rubber” (NR White). The acceptability of the material as a replacement to EPDM rubber was evaluated on material's resilience to: 1) durability change; 2) dimensional change; 3) compression change; 4) water adsorption; and 5) nozzle penetration.

To measure the data, three samples of each material were used for 1) physical sample measurements, durometer measurements, weight and dimensional changes measurements; 2) compression set measurements; 3) nozzle penetration measurements; and 4) control. The final data for each test and material was averaged over the data obtained from the three samples. A total of 12 samples were required for each test.

### Test Protocols

The following protocols were applied to evaluate the material acceptability.

### Compression Set Test

To measure the samples' compression, ⅜″ thick samples were compressed to ⅛″ in a Stainless-Steel test fixture. Upon conclusion of duration of each test the residual compression was measured and compared to the original condition for an evaluation.

### Nozzle Penetration/Leak Test

The stainless steel fixtures were fabricated to have the following end dimensions of O.D. (outer diameter) 1.40+/−0.01″ and I.D. (inner diameter) 1.30+/−0.01″ allowing a sample seal to be installed under compression of 90 lbs. This load replicates the nozzle loading of an installed Jet Pump Plug. This fixture was capped off on the top of the chamber to allow for pressurizing the inside of the test nozzle. The seal first was installed onto the test fixture, and then the fixture was loaded with 90 lb. and locked in a position maintaining the 90 lb. load between the seal and the nozzle. The test fixture further was submerged in the water bath for each test and removed at the completion of the test (same as with the “control” sample). Upon removal the fixture from the bath, it was allowed to cool enough to be handled. A test apparatus consisting of a valving and a flow-meter was used to apply air pressure to the test fixture. A test pressure of 40 psi (air) was applied to the inside of the test fixture for 1 minute. This pressure was derived by adding the external hydrostatic head of 58′ water pressure (58×0.4333)=25.1 psi+full vacuum inside the jet (14.7 psi)=39.8 psi, while the nozzle mockup was submerged in water. The presence of bubbles coming from the seal/nozzle interface served as indication of a leakage.

### 500° F. Melt Test

The melting test was performed at 500° F. During this test, each sample was completely submerged in water. The duration of the initial melt test was 8 hours. After 8 hours, the samples were removed, and the seals were inspected to determine if melting, to any degree, has occurred. If the testing material was found to be completely melted, the test has been considered to be concluded for that specific material. However, if a material sample was not yet completely melted, the 500° F. melt test was continued until the sample was fully melted or 24 hours of testing time has elapsed, whichever comes first. If the 500° F. melt testing was extended beyond 8 hours, the samples were pulled every 4 hours to evaluate the material condition. Upon inspection of the samples at each time increment, the samples were photographed, particularly to document present liquid and any solids that may remain. In some embodiments, the multiple testing vessels were utilized to reduce heat up and cooled down time. Upon conclusion of the 24-hour testing, each sample that has partially melted was submerged in water and heated to 212° F. for one hour and agitated. This test is conducted to understand the materials properties at elevated temperatures. The material condition of the samples at 212° F. was also documented with photographs and video.

The test is considered to be passed if the complete dissolution of the material into a liquid state is observed. When the high temperature viscosity of residual elastomer from 500° F. melt test is tested, the acceptance of the test is defined by an apparent drop in viscosity from ambient temperature to 212° F. As one of ordinary skill in the art would readily understand that since the goal is to demonstrate residual elastomer will not be capable of blocking flow orifice or adhere in any appreciable manner to Heat Exchange surfaces, this is a subjective test and it is acceptance is determined by one of ordinary skill in the art.

### 160° F. Durability Test

This durability test was conducted at 160° F. for three days (72 hours). The samples were checked every 12 hours to examine degradation and durometer change. During this test the samples remained submerged in the 160° F. water, unless the physical properties are being checked. A control sample was used for each alternate material. The control sample remained in the oven during the entire three-day test, and was physically separated from the incrementally checked samples. Upon conclusion of the three-day test, the control sample was removed and checked against the incrementally checked samples. Upon conclusion of the test, all samples (including the incrementally checked samples and the control sample) were photographed to document any degradation that occurred. Additionally, each sample was also tested for a compression set and nozzle penetration upon the conclusion of 160° F. durability test, using the nozzle penetration/leak test fixture.

The test is considered to be passed if: a) the durometer was determined to be greater than or equal to 20 Shore A; b) a satisfactory sealing against 40 psi internal pressure (in nozzle compression fixture) is observed to ensure that the compression set does not adversely affect the seal; c) nozzle compression does not penetrate (cut into) elastomer; d) zero leakage allowable; and e) no visible degradation of material is observed.

### 140° F. Durability Test

This durability test was conducted at 140° F. for twenty days (480 hours). The samples were checked every 24 hours to examine degradation and durometer change. Once degradation or durometer change has first been observed the samples were checked every 12 hours. During this test the samples remained submerged in the 140° F. water, unless the physical properties are being checked. A control sample was used for each alternate material. The control sample remained in the oven during the entire twenty-day test, and was physically separated from the incrementally checked samples. Upon conclusion of the twenty-day test, the control sample was removed and checked against the incrementally checked samples. Upon conclusion of the test, all samples (including the incrementally checked samples and the control sample) were photographed to document any degradation that occurred. Additionally, each sample was also tested for a compression set and nozzle penetration upon the conclusion of 140° F. durability test, using the nozzle penetration/leak test fixture.

The test is considered to be passed if: a) the durometer was determined to be greater than or equal to 20 Shore A; b) a satisfactory sealing against 40 psi internal pressure (in nozzle compression fixture) is observed to ensure that the compression set does not adversely affect the seal; c) nozzle compression does not penetrate (cut into) elastomer; d) zero leakage allowable; and e) no visible degradation of material is observed.

### 110° F. Stability Test

This stability test was conducted at 110° F. for thirty-seven days (888 hours). The samples were checked every 24 hours to examine degradation and durometer change. Once degradation or durometer change has first been observed the samples were checked every 12 hours. During this test the samples remained submerged in the 110° F. water, unless the physical properties are being checked. A control sample was used for each alternate material. The control sample remained in the oven during the entire thirty-seven day test, and be physically separated from the incrementally checked samples. Upon conclusion of the thirty-seven day test, the control sample was removed and checked against the incrementally checked samples. Upon conclusion of the test, all samples (including the incrementally checked samples and the control sample) were photographed to document any degradation that occurred. Additionally, each sample was also tested for a compression set and nozzle penetration upon the conclusion of 110° F. stability test, using the nozzle penetration/leak test fixture.

The test is considered to be passed if: a) the durometer was determined to be greater than or equal to 20 Shore A; b) a satisfactory sealing against 40 psi internal pressure (in nozzle compression fixture) is observed to ensure that the compression set does not adversely affect the seal; c) nozzle compression does not penetrate (cut into) elastomer; d) zero leakage allowable; and e) no visible degradation of material is observed.

### 200° F. and 212° F. Durability Check

Samples were kept at 160° F. for six days, then the temperature was raised for 200° F. and samples were kept at that temperature for two days, followed with a raise of a temperature to 212° F. and keeping the samples at that temperature for additional 4 days. The samples were checked approximately every 24 hours to examine a degradation and durometer change. During this test the samples remained submerged in the 200° F. and 212° F. water, unless the physical properties are being checked. Upon conclusion of the test, all samples were photographed to document any degradation that occurred. Additionally, each sample was also tested for a compression set and nozzle penetration upon the conclusion of 200° F. and 212° F. durability test, using the nozzle penetration/leak test fixture.

The test is considered to be passed if: a) the durometer was determined to be greater than or equal to 20 Shore A; b) a satisfactory sealing against 40 psi internal pressure (in nozzle compression fixture) is observed to ensure that the compression set does not adversely affect the seal; c) nozzle compression does not penetrate (cut into) elastomer; d) zero leakage allowable; and e) no visible degradation of material is observed.

### Results

Durometer Changes

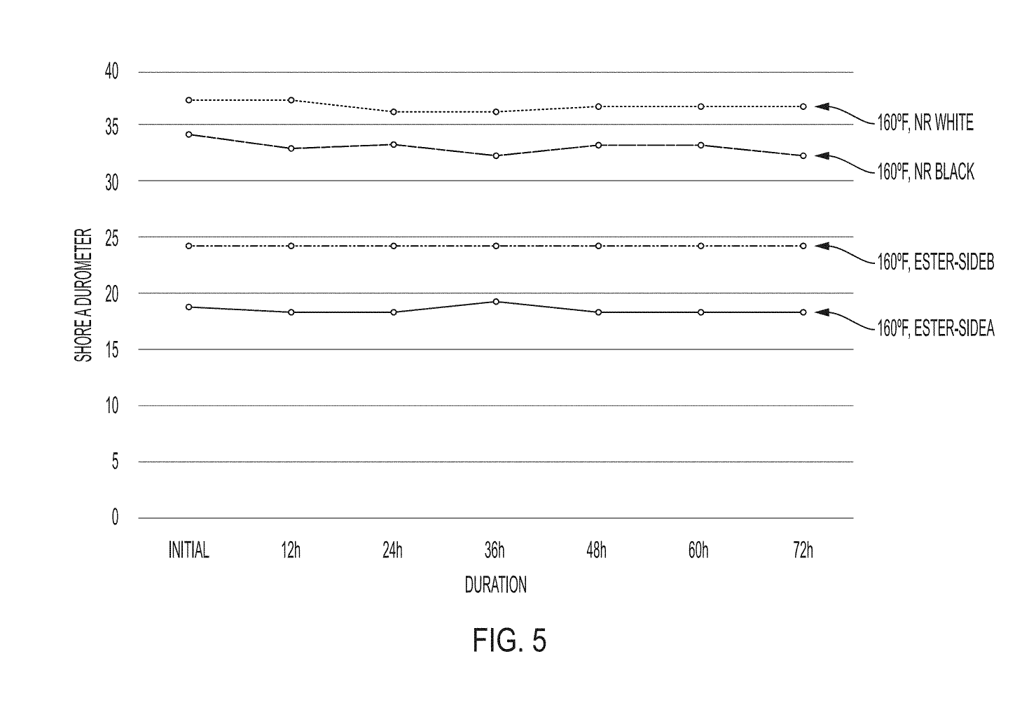

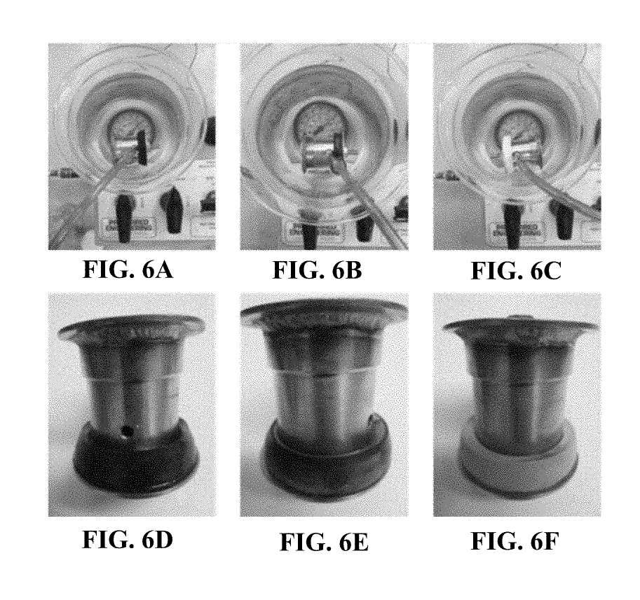

The 160° F. durability test results are shown in FIG. 5-6F. It was demonstrated that for 72 hour test all tested materials demonstrated stability for the whole duration of the test. Variations were well within the margin of error for measuring. No leaking or visible damage was observed.

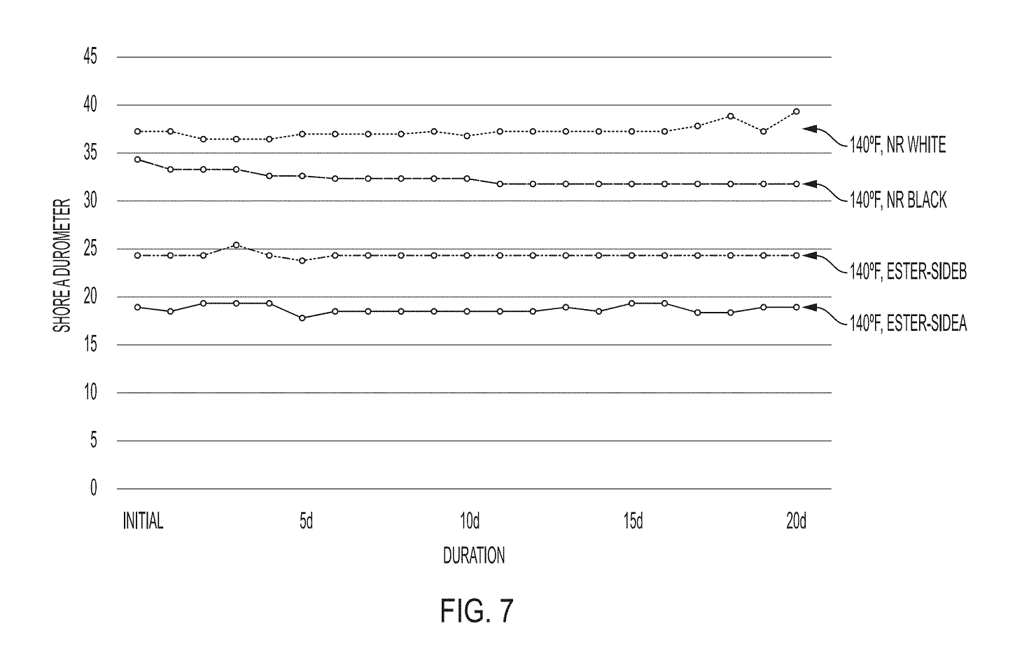

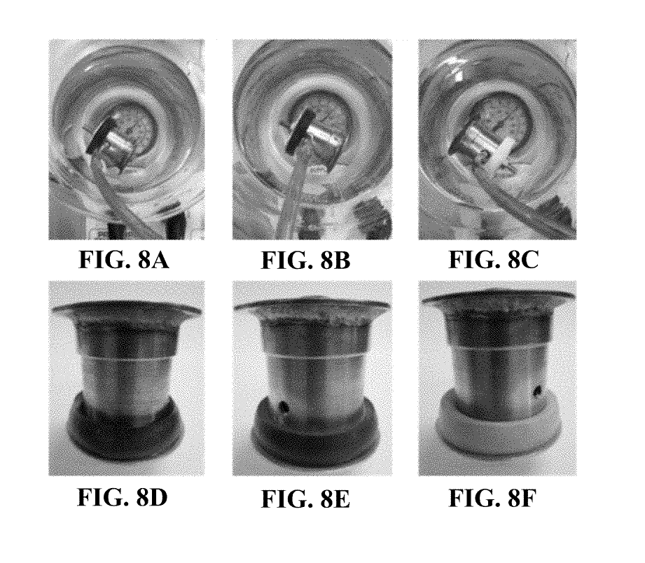

The 140° F. durability test results are shown in FIG. 7-8F. It was shown that for the 20 day test all tested materials exhibited stability for the whole duration of the test. No leaking or visible damage was observed.

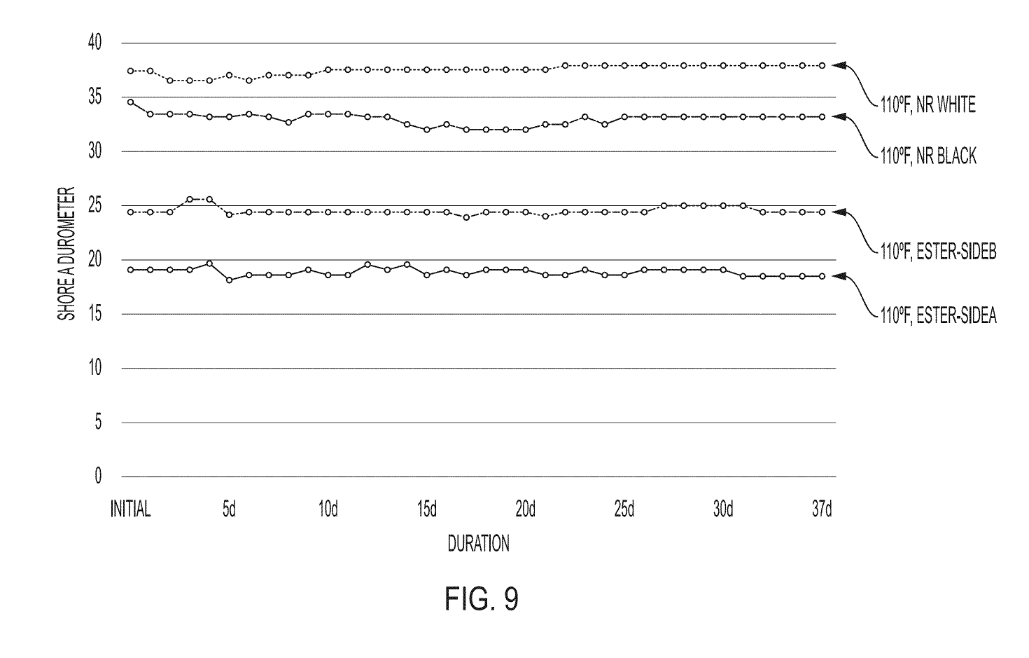

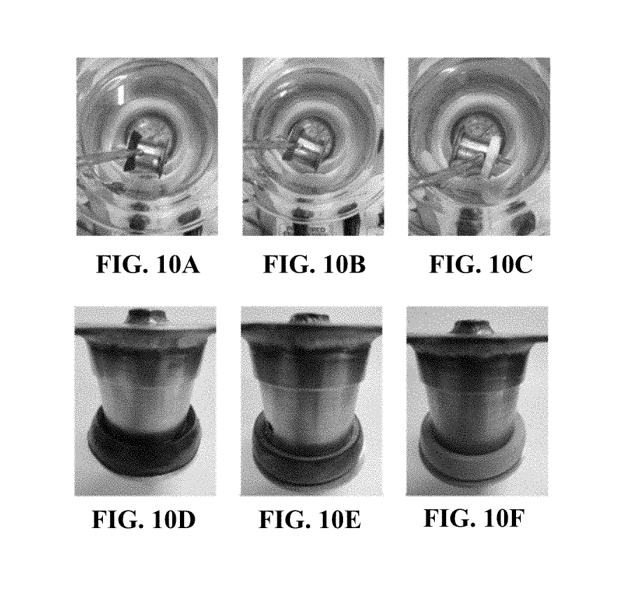

The 110° F. stability test results are shown in FIG. 9-10F. It was shown that for the 37 day test all tested materials exhibited stability for the whole duration of the test. Variations were well within the margin of error for measuring. No leaking or visible damage was observed.

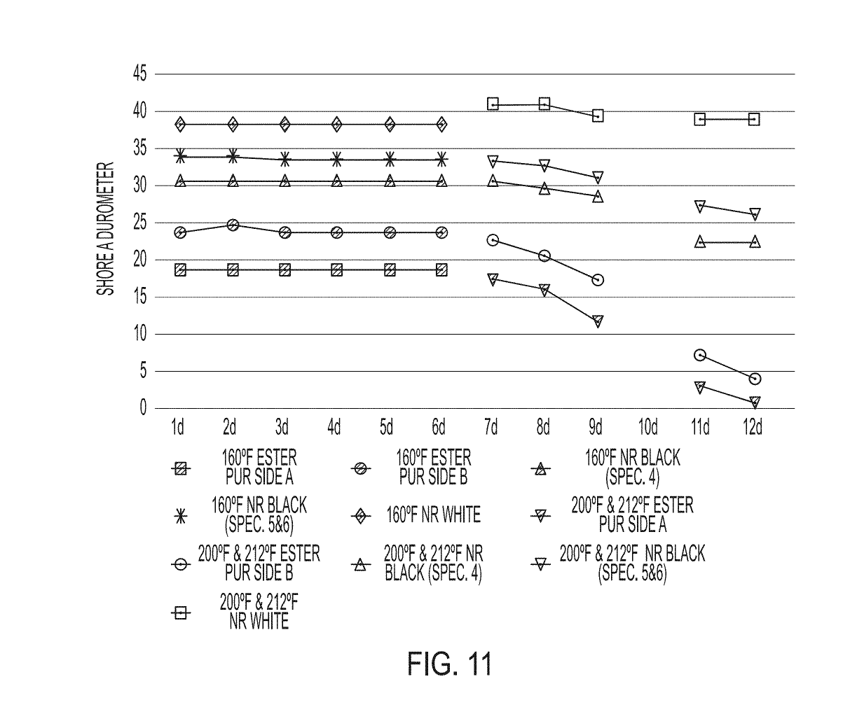

Data for extending testing at temperatures of 160° F.-212° F. is shown on FIG. 11.

Data for the changes in durometer hardness for 160° F., 140° F., 110° F. and 200° F. and 212° F. is shown in Tables 1-4. Temperature is measured in ° F., and durometer hardness is measured on Shore A Hardness scale.

TABLE 1
Durometer hardness measured at 160° F.

| Sample | Initial | 12 h | 24 h | 36 h | 48 h | 60 h | 72 h |
|---|---|---|---|---|---|---|---|
| Ester | 18-20 | 18-19 | 18-19 | 19-20 | 18-19 | 18-19 | 18-19 |
| PUR-Side A | | | | | | | |
| Ester | 24-25 | 24-25 | 24-25 | 24-25 | 24-25 | 24-25 | 24-25 |
| PUR-Side B | | | | | | | |
| NR Black | 34-35 | 33 | 33-34 | 32-33 | 33-34 | 33-34 | 32-33 |
| NR White | 37-38 | 37-38 | 36-37 | 36-37 | 36-38 | 36-38 | 36-38 |

TABLE 2
Durometer hardness measured at 140° F.

| Sample | Initial | 12 h | 24 h | 36 h | 48 h | 60 h | 72 h |
|---|---|---|---|---|---|---|---|
| Ester | 18-20 | | 18-19 | | 19-20 | | 19-20 |
| PUR-Side A | | | | | | | |
| Ester | 24-25 | | 24-25 | | 24-25 | | 25-26 |
| PUR-Side B | | | | | | | |
| NR Black | 34-35 | | 33-34 | | 33-34 | | 33-34 |
| NR White | 37-38 | | 37-38 | | 36-37 | | 36-37 |

| Sample | 4 d | 5 d | 6 d | 7 d | 8 d | 9 d | 10 d | 11 d | 12 d | 13 d |
|---|---|---|---|---|---|---|---|---|---|---|
| Ester | 19-20 | 17-19 | 18-19 | 18-19 | 18-19 | 18-19 | 18-19 | 18-19 | 18-19 | 18-20 |
| PUR-Side A | | | | | | | | | | |
| Ester | 24-25 | 23-25 | 24-25 | 24-25 | 24-25 | 24-25 | 24-25 | 24-25 | 24-25 | 24-25 |
| PUR-Side B | | | | | | | | | | |
| NR Black | 32-34 | 32-34 | 32-33 | 32-33 | 32-33 | 32-33 | 32-33 | 31-33 | 31-33 | 31-33 |
| NR White | 36-37 | 36-38 | 36-38 | 36-38 | 36-38 | 37-38 | 36-38 | 37-38 | 37-38 | 37-38 |

| Sample | 14 d | 15 d | 16 d | 17 d | 18 d | 19 d | 20 d |
|---|---|---|---|---|---|---|---|
| Ester | 18-19 | 19-20 | 19-20 | 18-19 | 18-19 | 18-20 | 18-20 |
| PUR-Side A | | | | | | | |
| Ester | 24-25 | 24-25 | 24-25 | 24-25 | 24-25 | 24-25 | 24-25 |
| PUR-Side B | | | | | | | |
| NR Black | 31-33 | 31-33 | 31-33 | 31-33 | 31-33 | 31-33 | 31-33 |
| NR White | 37-38 | 37-38 | 37-38 | 37-39 | 38-40 | 38-40 | 39-40 |

TABLE 3
Durometer hardness measured at 110° F.

| Sample | Initial | 12 h | 24 h | 36 h | 48 h | 60 h | 72 h | 4 d | 5 d | 6 d |
|---|---|---|---|---|---|---|---|---|---|---|
| Ester | 18-20 | | 18-20 | | 18-20 | | 18-20 | 19-20 | 17-19 | 18-19 |
| PUR-Side A | | | | | | | | | | |
| Ester | 24-25 | | 24-25 | | 24-25 | | 25-26 | 25-26 | 23-25 | 24-25 |
| PUR-Side B | | | | | | | | | | |
| NR Black | 34-35 | | 33-34 | | 33-34 | | 33-34 | 32-34 | 32-34 | 33-34 |
| NR White | 37-38 | | 37-38 | | 36-37 | | 36-37 | 36-37 | 36-38 | 36-37 |
| Sample | 7 d | 8 d | 9 d | 10 d | 11 d | 12 d | 13 d | 14 d | 15 d | 16 d |
| Ester | 18-19 | 18-19 | 18-19 | 18-19 | 18-19 | 18-19 | 19-20 | 18-20 | 19-20 | 18-19 |
| PUR-Side A | | | | | | | | | | |
| Ester | 24-25 | 24-25 | 24-25 | 24-25 | 24-25 | 24-25 | 24-25 | 24-25 | 24-25 | 24-25 |
| PUR-Side B | | | | | | | | | | |
| NR Black | 33-34 | 32-34 | 32-33 | 33-34 | 33-34 | 33-34 | 32-34 | 32-34 | 32-33 | 31-33 |
| NR White | 36-38 | 36-37 | 36-38 | 36-38 | 37-38 | 37-38 | 37-38 | 37-38 | 37-38 | 37-38 |
| Sample | 17 d | 18 d | 19 d | 20 d | 21 d | 22 d | 23 d | 24 d | 25 d | 26 d |
| Ester | 18-20 | 18-19 | 18-20 | 18-20 | 18-20 | 18-19 | 18-19 | 17-19 | 18-20 | 18-19 |
| PUR-Side A | | | | | | | | | | |
| Ester | 24-25 | 23-25 | 24-25 | 24-25 | 24-25 | 23-25 | 24-25 | 24-25 | 24-25 | 24-25 |
| PUR-Side B | | | | | | | | | | |
| NR Black | 32-33 | 31-33 | 31-33 | 31-33 | 31-33 | 32-33 | 32-33 | 32-33 | 32-34 | 32-33 |
| NR White | 37-38 | 37-38 | 37-38 | 37-38 | 37-38 | 37-38 | 37-39 | 37-39 | 37-39 | 37-39 |

| Sample | 27 d | 28 d | 29 d | 30 d | 31 d | 32 d | 33 d | 34 d | 35 d | 36 d | 37 d | control |
|---|---|---|---|---|---|---|---|---|---|---|---|---|
| Ester | 18-19 | 18-20 | 18-20 | 18-20 | 18-20 | 18-20 | 18-19 | 18-19 | 18-19 | 18-19 | 18-19 | 17-18 |
| PUR- | | | | | | | | | | | | |
| Side A | | | | | | | | | | | | |
| Ester | 24-25 | 24-25 | 24-26 | 24-26 | 24-26 | 24-26 | 24-26 | 24-25 | 24-25 | 24-25 | 24-25 | 23-24 |
| PUR- | | | | | | | | | | | | |
| Side B | | | | | | | | | | | | |
| NR Black | 32-34 | 32-34 | 32-34 | 32-34 | 32-34 | 32-34 | 32-34 | 32-34 | 32-34 | 32-34 | 32-34 | 33-34 |
| NR White | 37-39 | 37-39 | 37-39 | 37-39 | 37-39 | 37-39 | 37-39 | 37-39 | 37-39 | 37-39 | 37-39 | 36-37 |

TABLE 4
Durometer hardness measured at 160° F for 6 days, then at 200°
F. for 2 days and then at 212° F. for 4 days.

| Sample | Initial | 12 h | 24 h | 36 h | 48 h | 60 h | 72 h | 4 d | 5 d | 6 d |
|---|---|---|---|---|---|---|---|---|---|---|
| Ester | 18-19 | | 18-19 | | 18-19 | | 18-19 | 18-19 | 18-19 | 18-19 |
| PUR-Side A | | | | | | | | | | |
| Ester | 23-24 | | 23-24 | | 24-25 | | 23-24 | 23-24 | 23-24 | 23-24 |
| PUR-Side B | | | | | | | | | | |
| NR | 32-33 | | 30-31 | | 30-31 | | 30-31 | 30-31 | 30-31 | 30-31 |
| Black | | | | | | | | | | |
| (spec. 4) | | | | | | | | | | |
| NR | 34-35 | | 33-34 | | 33-34 | | 32-34 | 32-34 | 32-34 | 32-34 |
| Black | | | | | | | | | | |
| (spec. 5&6) | | | | | | | | | | |
| NR | 37-38 | | 37-38 | | 37-38 | | 37-38 | 37-38 | 37-38 | 37-38 |
| White | | | | | | | | | | |
| Topside | | | | | | | | | | |
| NR | | | | | | | | | | |
| White- | | | | | | | | | | |
| Submerged | | | | | | | | | | |
| Side | | | | | | | | | | |

| Sample | 7 d | 8 d | 9 d | 10 d | 11 d | 12 d |
|---|---|---|---|---|---|---|
| Ester | 17-18 | 15-17 | 11-13 | | 3-5 | 1-2 |
| PUR-Side A | | | | | | |
| Ester | 22-23 | 20-21 | 17-18 | | 7-8 | 4-5 |
| PUR-Side B | | | | | | |
| NR Black | 30-31 | 29-30 | 28-29 | | 22-23 | 22-23* |
| (spec. 4) | | | | | | |
| NR Black | 32-34 | 32-33 | 30-31 | | 26-28 | 25-27* |
| (spec. 5&6) | | | | | | |
| NR White | 40-41 | 40-41 | 41-42 | | 40-41 | 40-41 |
| Topside | | | | | | |
| NR White- | | | 38-40 | | 38-39 | 38-39 |
| Submerged | | | | | | |
| Side | | | | | | |

*NR Black control @ 0 + 12 days = 29-30 A

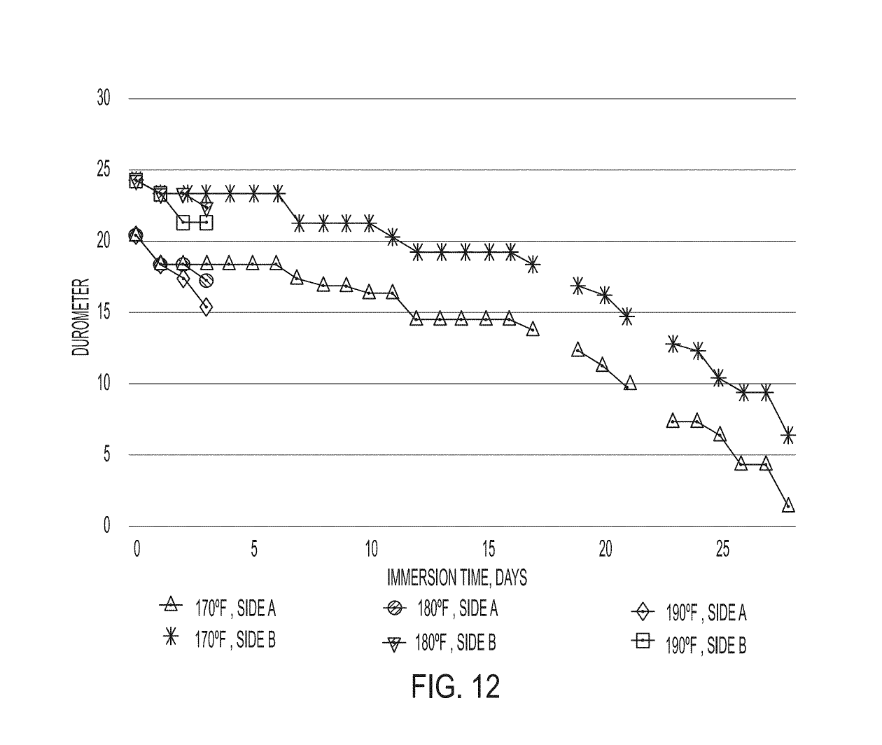

The 190° F.-170° F. durability test results are shown in FIG. 12. During the 190° F. durability test, at a second day one tear failure was observed. Both faces of the Ester PUR plug were tested. It was found that the seal tear did not appear to be dependent upon which face of the Ester PUR plug was in contact with the nozzle lip. In the case of the observed failure at 190° F., the lower durometer face was in contact with the nozzle. All of the intact fixtures passed leak-check testing at 40 psi. Test stopped at day 3 to match minimum immersion of 160° F. per original test plan. It was concluded that the Ester PUR is not a viable material at this temperature.

During the 180° F. durability test, at a second day two tear failures were observed. Both faces of the Ester PUR plug were tested. It was found that the seal tear did not appear to be dependent upon which face of the Ester PUR plug is in contact with the nozzle lip. In case of the both observed failures at 180° F., the higher durometer face was in contact with the nozzle. All of the intact fixtures passed leak-check testing at 40 psi. Test stopped at day 3 to match minimum immersion of 160° F. per original test plan. It was concluded that the Ester PUR is not a viable material at this temperature.

During the 170° F. durability test, at day 28 of the test, three of the four fixtures were leaking, resulting in the end of the testing. It was shown that the seals passed the leak testing on days 3, 7, 14, 21, 23, and then failed on the 28^{th} day of the test. It is speculated that if daily tests were performed, the failure most likely would occurred at day 25, since the results on day 23 have shown that the seals were still leak-tight and the durometer on the day 24^{th} remained unchanged (Tables 5-7). It was further found that the ability of the material to seal at significantly reduced durometers is encouraging, although the failures at 180° F. raise concerns of the “tipping point” of the Ester PUR being too close to 170° F. to list it as a viable installation temperature. Durometer drop was found to be outside of the scope of allowable change for Seismic qualification.

TABLE 5
Durometer hardness at 170° F.

| Sample | Initial | 1 d | 2 d | 3 d | 4 d | 5 d |
|---|---|---|---|---|---|---|
| Ester PUR- | 20-21 | 18-19 | 18-19 | 18-19 | 18-19 | 18-19 |
| Side A | | | | | | |
| Ester PUR- | 24-25 | 23-24 | 23-24 | 23-24 | 23-24 | 23-24 |
| Side B | | | | | | |

| Sample | 22 d | 23 d | 24 d | 25 d | 26 d | 27 d | 28 d |
|---|---|---|---|---|---|---|---|
| Ester | n.d | 7-8 | 7-8 | 6-7 | 4-5 | 4-5 | 1-2 |
| PUR-Side A | | | | | | | |
| Ester | n.d | 12-14 | 12-13 | 10-11 | 9-10 | 9-10 | 6-7 |
| PUR-Side B | | | | | | | |

| Sample | 6 d | 7 d | 8 d | 9 d | 10 d | 11 d | 12 d | 13 d |
|---|---|---|---|---|---|---|---|---|
| Ester | 18-19 | 17-18 | 16-18 | 16-18 | 16-17 | 16-17 | 14-15 | 14-15 |
| PUR-Side A | | | | | | | | |
| Ester | 23-24 | 21-22 | 21-22 | 21-22 | 21-22 | 20-21 | 19-20 | 19-20 |
| PUR-Side B | | | | | | | | |
| Sample | 14 d | 15 d | 16 d | 17 d | 18 d | 19 d | 21 d | 21 d |
| Ester | 14-15 | 14-15 | 14-15 | 13-15 | n.d | 12-13 | 11-12 | 9-11 |
| PUR-Side A | | | | | | | | |
| Ester | 19-20 | 19-20 | 19-20 | 18-19 | n.d | 16-18 | 15-18 | 14-16 |
| PUR-Side B | | | | | | | | |

TABLE 6
Durometer hardness at 180° F.

| Sample | Initial | 1 d | 2 d | 3 d |
|---|---|---|---|---|
| Ester PUR-Side A | 20-21 | 18-19 | 18-19 | 17-18 |
| Ester PUR-Side B | 24-25 | 23-24 | 23-24 | 22-23 |

TABLE 7
Durometer hardness at 190° F.

| Sample | Initial | 1 d | 2 d | 3 d |
|---|---|---|---|---|
| Ester PUR-Side A | 20-21 | 18-19 | 17-18 | 15-16 |
| Ester PUR-Side B | 24-25 | 23-24 | 21-22 | 21-22 |

Dimensional Change

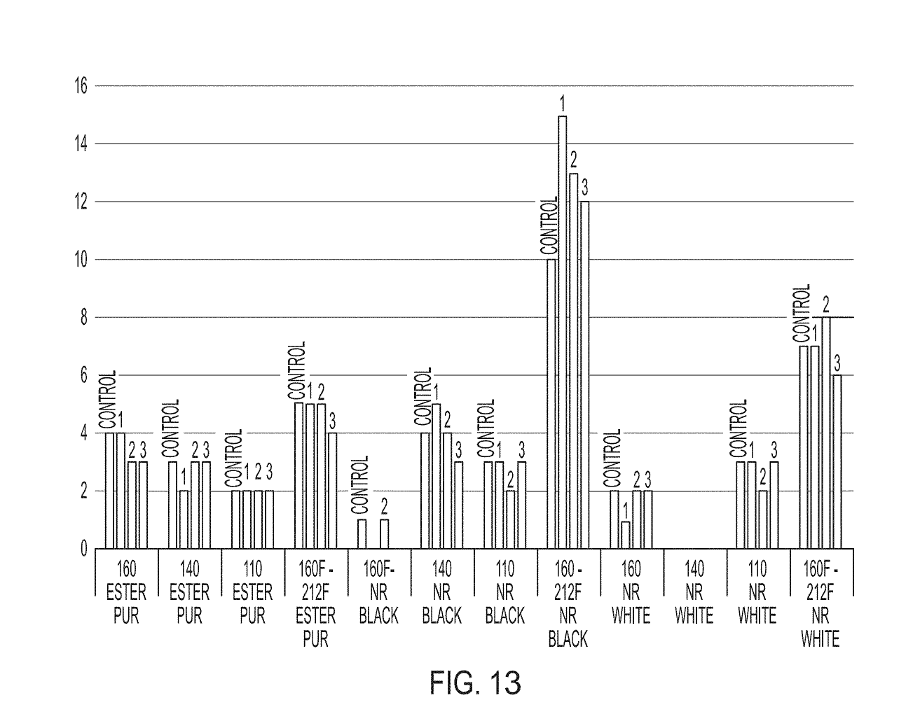

The change in thickness in samples measured at 160° F., 140° F., 110° F., and extended 160° F.-212° F. is shown on FIG. 13 and Tables 8-11. It was shown that at 160° F. Durability Test, Ester PUR exhibited the most dimensional change of all samples, which was an expected result of exposure to water at elevated temperatures. Natural Rubber Black exhibited almost no dimensional change, while the Natural Rubber White exhibited only minimal dimensional change.

Similar results were observed at 140° F. Durability Test. Again, Ester PUR exhibited the most dimensional change of all samples, which again was an expected result of exposure to water at elevated temperatures. Both Natural Rubber Black and Natural Rubber White exhibited almost no dimensional changes. These results are interesting as the test duration of 20 days seems not to affect the material dimensions, but increase in weight due to water absorption by an equivalent percentage. Samples evaluated at 110° F. Stability Test exhibited similar thickness increases, reflecting the durometer stability at this temperature/duration.

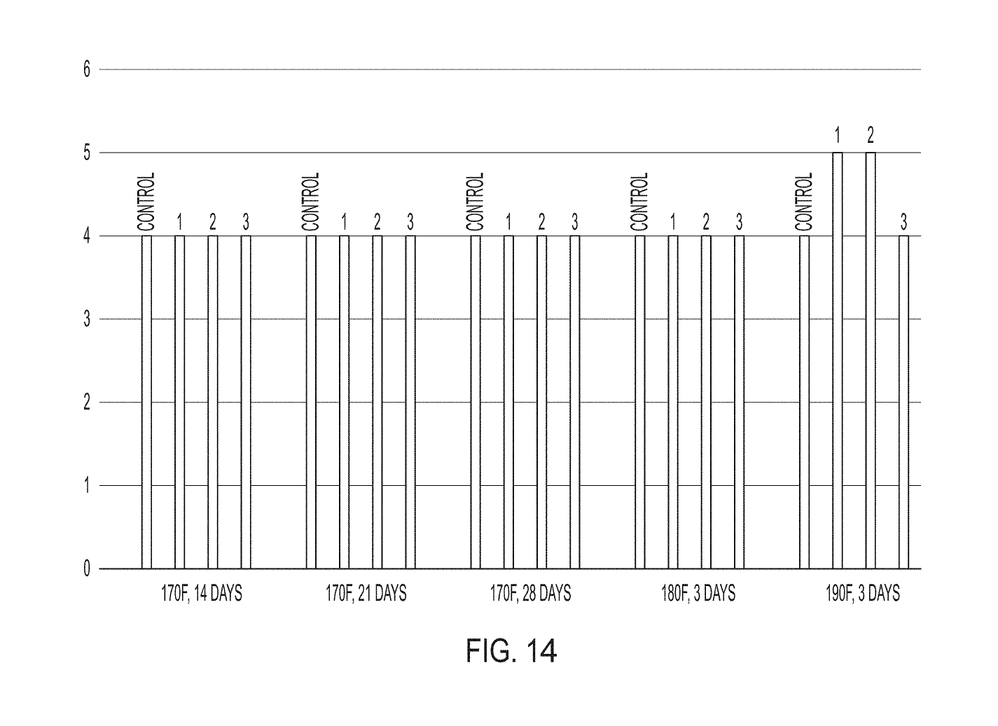

The dimensional data obtained for 190° F.-170° F. is shown on FIG. 14 and Table 12. Samples measured at 190° F. Durability Test demonstrated that Ester PUR showed the most gains at this temperature. Based on the data received for the samples measured at extended temperatures of 160-212° F., one of ordinary skill in the art can speculate that the material reacts to temperature more readily than time. Samples measured at 180° F. Durability Test showed that Ester PUR did not gain more thickness in 3 days than samples run at 170° F. over a much longer period. The stability of Ester PUR was surprising given the 28 day duration and the deterioration of the durometer.

TABLE 8
Weight and thickness after 72 hours at 160° F.

| | | Weight (grams) | | Percent | Thickness (inch) | | Mils |
|---|---|---|---|---|---|---|---|
| Material | Specimen | Initial | Final | Increase | Initial | Final | Increase |
| Ester | Control | 16.8054 | 17.2144 | 2.434 | 0.380 | 0.384 | 4 |
| PUR | 1 | 16.6998 | 17.1067 | 2.437 | 0.380 | 0.384 | 4 |
| | 2 | 16.7334 | 17.1408 | 2.435 | 0.380 | 0.383 | 3 |
| | 3 | 16.7228 | 17.1293 | 2.431 | 0.379 | 0.383 | 3 |
| NR | Control | 14.6257 | 14.8108 | 1.266 | 0.388 | 0.389 | 1 |
| Black | 1 | 14.7279 | 14.8976 | 1.152 | 0.383 | 0.383 | 0 |
| | 2 | 14.5799 | 14.7493 | 1.162 | 0.387 | 0.388 | 1 |
| | 3 | 14.6527 | 14.8266 | 1.187 | 0.382 | 0.382 | 0 |
| NR | Control | 14.2541 | 14.4345 | 1.266 | 0.384 | 0.386 | 2 |
| White | 1 | 14.1692 | 14.3383 | 1.193 | 0.383 | 0.384 | 1 |
| | 2 | 14.0719 | 14.2424 | 1.212 | 0.384 | 0.386 | 2 |
| | 3 | 14.0898 | 14.2592 | 1.202 | 0.384 | 0.386 | 2 |

TABLE 9
Weight and thickness after 20 days at 140° F.

| | | Weight (grams) | | Percent | Thickness (inch) | | Mils |
|---|---|---|---|---|---|---|---|
| Material | Specimen | Initial | Final | Increase | Initial | Final | Increase |
| Ester | Control | 16.4182 | 16.7569 | 2.063 | 0.379 | 0.382 | 3 |
| PUR | 1 | 16.7100 | 17.0509 | 2.040 | 0.379 | 0.381 | 2 |
| | 2 | 16.6974 | 17.0330 | 2.010 | 0.379 | 0.382 | 3 |
| | 3 | 16.6441 | 16.9813 | 2.026 | 0.379 | 0.382 | 3 |
| NR | Control | 14.6321 | 14.9995 | 2.511 | 0.381 | 0.385 | 4 |
| Black | 1 | 14.6189 | 14.9851 | 2.505 | 0.381 | 0.386 | 5 |
| | 2 | 14.6110 | 14.9221 | 2.129 | 0.390 | 0.394 | 4 |
| | 3 | 14.4609 | 14.8077 | 2.398 | 0.385 | 0.388 | 3 |
| NR | Control | 14.2429 | 14.5519 | 2.170 | 0.385 | 0.385 | 0 |
| White | 1 | 14.0483 | 14.3379 | 2.061 | 0.385 | 0.385 | 0 |
| | 2 | 14.1068 | 14.4790 | 2.638 | 0.382 | 0.382 | 0 |
| | 3 | 14.0667 | 14.3627 | 2.104 | 0.384 | 0.384 | 0 |

TABLE 10
Weight and thickness after 37 days at 110° F.

| | | Weight (grams) | | Percent | Thickness (inch) | | Mils |
|---|---|---|---|---|---|---|---|
| Material | Specimen | Initial | Final | Increase | Initial | Final | Increase |
| Ester | Control | 16.5907 | 16.8260 | 1.418 | 0.379 | 0.381 | 2 |
| PUR | 1 | 16.8267 | 17.0673 | 1.430 | 0.380 | 0.382 | 2 |
| | 2 | 16.5764 | 16.7891 | 1.283 | 0.380 | 0.382 | 2 |
| | 3 | 16.3114 | 16.5337 | 1.363 | 0.379 | 0.381 | 2 |
| NR | Control | 14.5594 | 14.8506 | 2.000 | 0.385 | 0.388 | 3 |
| Black | 1 | 14.6549 | 14.9012 | 1.681 | 0.390 | 0.393 | 3 |
| | 2 | 14.6062 | 14.8974 | 1.994 | 0.383 | 0.385 | 2 |
| | 3 | 14.4893 | 14.7474 | 1.781 | 0.384 | 0.387 | 3 |
| NR | Control | 14.0263 | 14.2670 | 1.716 | 0.384 | 0.387 | 3 |
| White | 1 | 14.2239 | 14.4494 | 1.585 | 0.383 | 0.386 | 3 |
| | 2 | 14.0467 | 14.2713 | 1.599 | 0.384 | 0.386 | 2 |
| | 3 | 14.2327 | 14.4587 | 1.588 | 0.384 | 0.387 | 3 |

TABLE 11
Weight and thickness after 6 days at 160° F., then 2 days
at 200° F. and then 4 days at 212° F.

| | | Weight (grams) | | Percent | Thickness (inch) | | Mils |
|---|---|---|---|---|---|---|---|
| Material | Specimen | Initial | Final | Increase | Initial | Final | Increase |
| Ester | Control | 16.8427 | 17.4389 | 3.540 | 0.379 | 0.384 | 5 |
| PUR | 1 | 16.7894 | 17.3795 | 3.515 | 0.379 | 0.384 | 5 |
| | 2 | 16.8628 | 17.452 | 3.494 | 0.380 | 0.385 | 5 |
| | 3 | 16.8581 | 17.4608 | 3.575 | 0.380 | 0.384 | 4 |
| NR | Control | 14.6083 | 15.3664 | 5.190 | 0.385 | 0.395 | 10 |
| Black | 1 | 14.6566 | 15.5921 | 6.383 | 0.393 | 0.408 | 15 |
| | 2 | 14.6661 | 15.4915 | 5.628 | 0.396 | 0.409 | 13 |
| | 3 | 14.4535 | 15.2868 | 5.765 | 0.389 | 0.401 | 12 |
| NR | Control | 14.0906 | 14.6306 | 3.832 | 0.385 | 0.392 | 7 |
| White | 1 | 14.0494 | 14.6372 | 4.184 | 0.384 | 0.391 | 7 |
| | 2 | 14.1170 | 14.6948 | 4.093 | 0.382 | 0.390 | 8 |
| | 3 | 14.2440 | 14.8259 | 4.085 | 0.385 | 0.391 | 6 |

TABLE 12
Weight and thickness for Ester PUR at 170° F., 180° F. and 190° F.

| | Immersion | | Weight (grams) | | Percent | Thickness (inch) | | Mils |
|---|---|---|---|---|---|---|---|---|
| Specimen | Period | Temp | Initial | Final | Increase | Initial | Final | Increase |
| Control | 14 d | 170° F. | 16.7401 | 17.2156 | 2.840 | 0.379 | 0.383 | 4 |
| 1 | | | 16.6994 | 17.1573 | 2.742 | 0.379 | 0.383 | 4 |
| 2 | | | 16.7540 | 17.2157 | 2.756 | 0.379 | 0.383 | 4 |
| 3 | | | 16.7606 | 17.2190 | 2.735 | 0.379 | 0.383 | 4 |
| Control | 21 d | 170° F. | 16.7401 | 17.2202 | 2.868 | 0.379 | 0.383 | 4 |
| 1 | | | 16.6994 | 17.1800 | 2.878 | 0.379 | 0.383 | 4 |
| 2 | | | 16.7540 | 17.2379 | 2.888 | 0.379 | 0.383 | 4 |
| 3 | | | 16.7606 | 17.2410 | 2.866 | 0.379 | 0.383 | 4 |
| Control | 28 d | 170° F. | 16.7401 | 17.2434 | 3.007 | 0.379 | 0.383 | 4 |
| 1 | | | 16.6994 | 17.1960 | 2.974 | 0.379 | 0.383 | 4 |
| 2 | | | 16.7540 | 17.2567 | 3.000 | 0.379 | 0.383 | 4 |
| 3 | | | 16.7606 | 17.2595 | 2.977 | 0.379 | 0.383 | 4 |
| Control | 3 d | 180° F. | 16.8947 | 17.3758 | 2.847 | 0.380 | 0.384 | 4 |
| 1 | | | 16.8345 | 17.3134 | 2.845 | 0.380 | 0.384 | 4 |
| 2 | | | 16.6790 | 17.1515 | 2.833 | 0.379 | 0.383 | 4 |
| 3 | | | 16.7509 | 17.2258 | 2.835 | 0.379 | 0.384 | 4 |
| Control | 3 d | 190° F. | 16.9149 | 17.4280 | 3.033 | 0.380 | 0.384 | 4 |
| 1 | | | 16.7351 | 17.2396 | 3.015 | 0.379 | 0.384 | 5 |
| 2 | | | 16.8566 | 17.3693 | 3.042 | 0.380 | 0.385 | 5 |
| 3 | | | 16.8240 | 17.3328 | 3.024 | 0.380 | 0.384 | 4 |

Compression Test

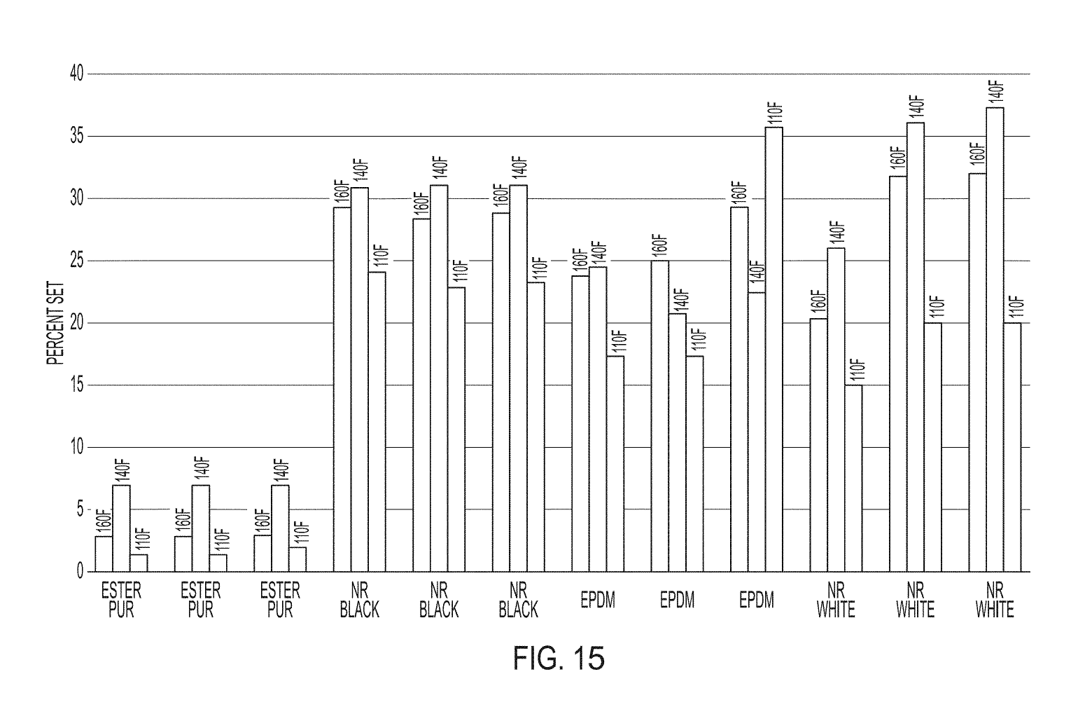

At 160° F. test, Ester PUR samples exhibited an impressive resistance to compression set, especially in comparison to the EPDM control sample. At 140° F. Durability Test, it was found that for all the alternate materials 140° F. temperature proved to produce the highest compression set. One of ordinary skill in the art based on these results could hypothesize a type of relationship between time and temperature. Again, Ester PUR exhibited an impressive resistance to compression set 110° F. Stability Test and shown the lowest compression set values. However, the difference between EPDM and Natural Rubber was not shown to be as great as anticipated. Ester PUR showed the lowest compression set by a wide margin, making this the clear preferential material under the given temperature specification. The data is shown on FIG. 15 and Tables 13-15. The compression test for samples at 190° F.-170° F. was not performed.

TABLE 13
Compression Set values after 72 hours at 160° F.

Thickness (inch)

| Material | Initial | Final | Spacer | Percent Set |
|---|---|---|---|---|
| Ester PUR | 0.379 | 0.375 | 0.246 | 3.00 |
| | 0.379 | 0.375 | 0.246 | 3.00 |
| | 0.379 | 0.375 | 0.246 | 3.00 |
| NR Black | 0.389 | 0.347 | 0.246 | 29.4 |
| | 0.383 | 0.344 | 0.246 | 28.5 |
| | 0.388 | 0.347 | 0.246 | 28.9 |
| EPDM | 0.389 | 0.355 | 0.246 | 23.8 |
| | 0.390 | 0.354 | 0.246 | 25.0 |
| | 0.389 | 0.347 | 0.246 | 29.4 |
| NR White | 0.384 | 0.356 | 0.247 | 20.4 |
| | 0.382 | 0.339 | 0.247 | 31.9 |
| | 0.384 | 0.340 | 0.247 | 32.1 |

TABLE 14
Compression Set values after 20 days at 140° F.

Thickness (inch)

| Material | Initial | Final | Spacer | Percent Set |
|---|---|---|---|---|
| Ester PUR | 0.378 | 0.369 | 0.251 | 7.03 |
| | 0.379 | 0.370 | 0.251 | 7.09 |
| | 0.378 | 0.369 | 0.251 | 7.03 |
| NR Black | 0.386 | 0.344 | 0.251 | 31.1 |
| | 0.386 | 0.344 | 0.251 | 31.1 |
| | 0.386 | 0.344 | 0.251 | 31.1 |
| EPDM | 0.389 | 0.355 | 0.251 | 24.6 |
| | 0.389 | 0.360 | 0.251 | 21.0 |
| | 0.389 | 0.358 | 0.251 | 22.5 |
| NR White | 0.385 | 0.350 | 0.251 | 26.1 |
| | 0.381 | 0.334 | 0.251 | 36.2 |
| | 0.382 | 0.333 | 0.251 | 37.4 |

TABLE 15
Compression Set values after 37 days at 110° F.

Thickness (inch)

| Material | Initial | Final | Spacer | Percent Set |
|---|---|---|---|---|
| Ester PUR | 0.379 | 0.377 | 0.245 | 1.49 |
| | 0.379 | 0.377 | 0.245 | 1.49 |
| | 0.379 | 0.376 | 0.245 | 2.24 |
| NR Black | 0.385 | 0.351 | 0.245 | 24.3 |
| | 0.379 | 0.348 | 0.245 | 23.1 |
| | 0.383 | 0.350 | 0.245 | 23.4 |
| EPDM | 0.388 | 0.363 | 0.245 | 17.5 |
| | 0.388 | 0.363 | 0.245 | 17.5 |
| | 0.387 | 0.336 | 0.245 | 35.9 |
| NR White | 0.384 | 0.363 | 0.245 | 15.1 |
| | 0.384 | 0.356 | 0.245 | 20.1 |
| | 0.384 | 0.356 | 0.245 | 20.1 |

Water Adsorption (by Weight)

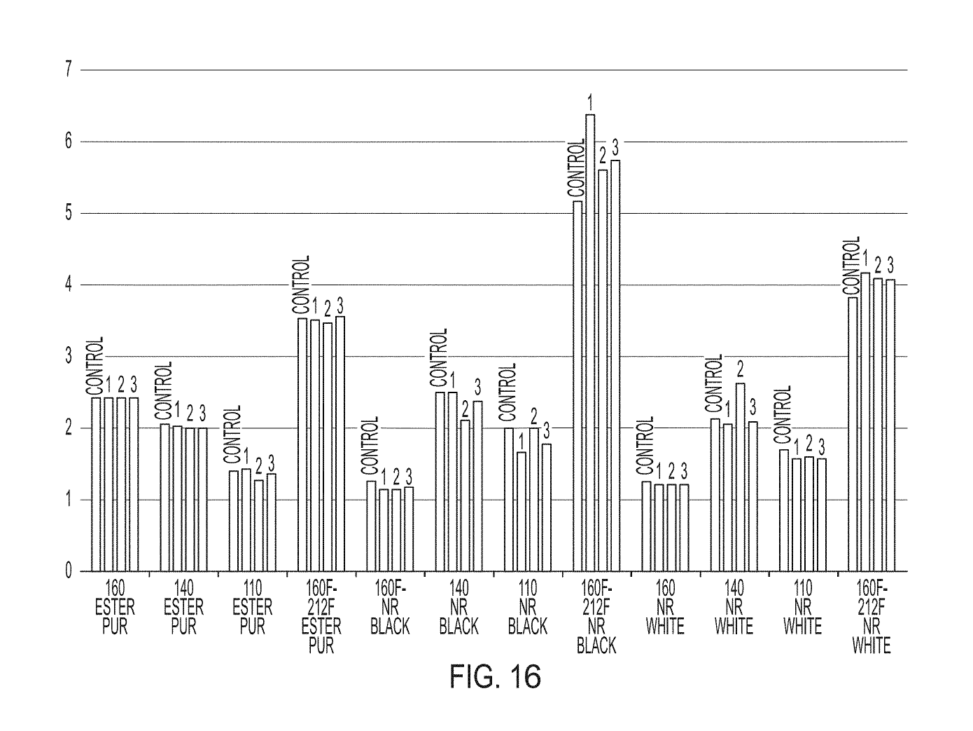

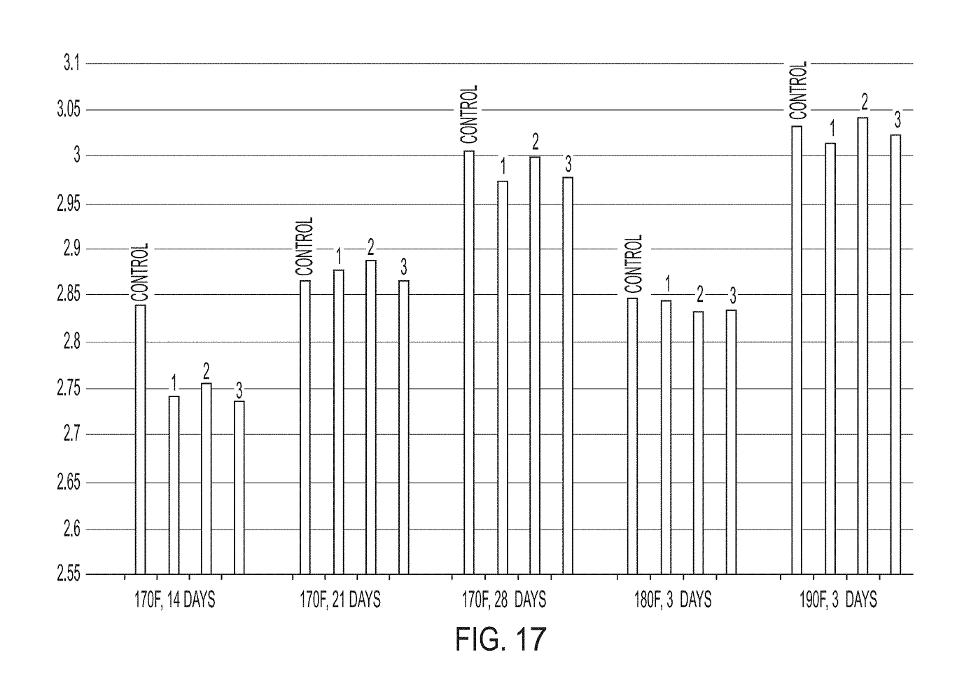

Samples were tested at 160° F. to measure a water gain. It was shown that Ester PUR samples exhibited the highest weight gain. As one or ordinary skill in the art would readily appreciate due to the material propensity for hydrolysis, this water gain is anticipated. When tested at 140° F., the Natural Rubber sample's weight gain exceeded that of 160° F. over 72 hours, while water gain by Ester PUR sample was less than one measured at 160° F. over 72 hours. These results allow one to examine how time affects a material's ability to resist water absorption in comparison to temperature. When tested at 110° F., Ester PUR sample exhibited the lowest water absorption, indicating a better resistance to the water environment than would have been anticipated. The test at 190° F. showed that Ester PUR sample exhibits a weight increase indicative of water absorption due to hydrolysis over a 3 day period. This water gain exceeded the gains at 170° F. at 28 days, further correlating the effect of temperature as the prime motivator for hydrolysis. The test at 180° F. showed that Ester PUR sample has a weight increase marginally greater than that observed at 160° F. over 3 day period. The test at 170° F. showed that Ester PUR has weight increase in the anticipated rate observed from tests at lower temperatures. Longer test duration showed increase in water retention which was also correlated with the observed loss of durometer. The data is shown on FIG. 16 and FIG. 17, as well as Tables 8-12.

Nozzle Penetration/Leak Test

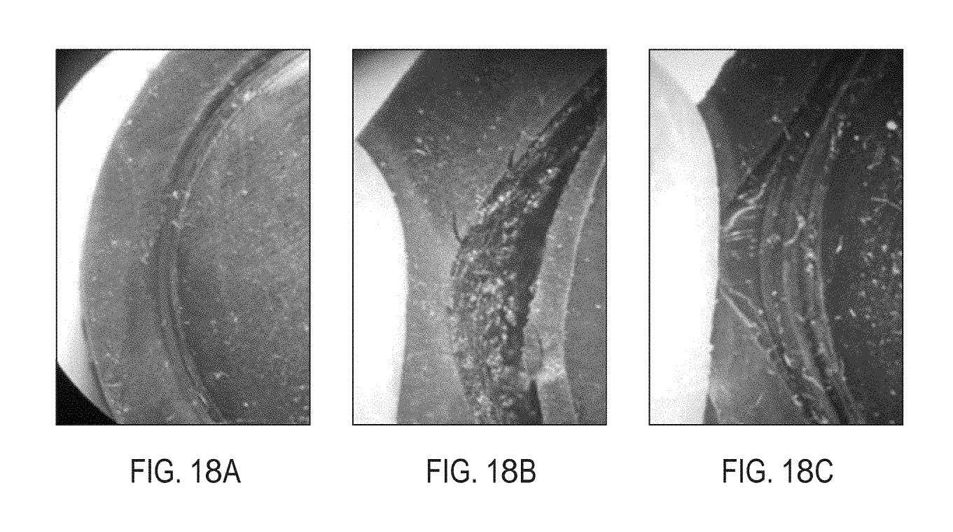

At 160° F. test, the Ester PUR samples exhibited the most deformation under load while the white Natural Rubber shows the least. Without wishing to be bound to any theory these results could be attributed to differences in starting durometer. Further, it was shown that the Ester PUR samples exhibited the greatest deflection when the nozzle was compressed with 90 lbs. load. No nozzle penetrations or leaking seal, all materials pass the test. At 140° F. Durability Test and 110° F. Stability Test, the Ester PUR samples showed similar properties and behavior observed as 160° F. test. When 190° F. Durability Test was conducted, it was found that the Ester PUR samples failed to prevent the mock nozzle from cutting into the seal after 2 and 3 days. It was found that despite seal tear, fixtures 9 and 11 held pressure. It was further demonstrated that Fixture 9 held pressure with no leaking, while fixture 11 self-sealed after an initial expulsion of air. With respect to the fixture 12, the reduced force load of the fixture 12 was found to be due to partial tear of seal (FIG. 18C). FIG. 18A depicts an intact seal showing typical nozzle compression set; FIG. 18B depicts a torn seal showing a deep fracture; and FIG. 18C shows partial tear of seal. Based on these results it was concluded that failures at 190° F. make this material not viable for use at this temperature.

When 180° F. Durability Test was conducted, it was found that the Ester PUR sample failed to prevent the mock nozzle from cutting into the seal after 2 days. Similarly to the results obtained at 190° F., the failures of the Ester PUR samples observed at 180° F. make this material not viable for use at this temperature. When the samples underwent 170° F. Durability Test, the Ester PUR samples showed resistance to nozzle penetration up to 28 days. However, by the 28^{th} day, the seals failed to prevent the leaking. The leaking, however, was not attributed to the presence of a tear but to low durometer which was unable to withstand the applied pressure. Given the loss of durometer and the inability to seal at 28 days, it was concluded that this material is not viable for use at this temperature.

It was further found that all Ester PUR samples failed when the temperature exceeded 160° F. At 200° F. and 212° F. a rapid durometer loss with observed along with nozzle penetration.

500° F. Melt Test

Samples were subjected to the 500° F. melt test. The results are shown in Table 16. It was found that the Ester PUR samples dissolved into a mostly liquid state. Any remaining solids were not cohesive. It was further found that the Natural Rubber Black left a residue which flowed with properties of a non-Newtonian fluid. Further, it was found that Natural Rubber without Carbon Black (white) retained mechanical properties the most of all tested samples. These findings contradicted the common assumption that presence of Carbon Black enhances crosslinking, and thus, makes the rubber more durable. White Natural Rubber still appeared to behave as a non-Newtonian fluid.

TABLE 16
500° F. Melt Test Results

| | | Hours | pH Im- | Water | |
|---|---|---|---|---|---|
| No. | | of Im- | mersion | Boil | |
| Test | Material | mersion | Water | Video | Results |
| 1 | Ester | 8 | 3.77 | No | Dissolved completely; |
| | PUR | | | | light, fluffy solids |
| | | | | | (polyureas) precipitated |
| | | | | | on standing |
| 2 | NR Black | 8 | 7.76 | Yes | Soft, creamy residue |
| 3 | NR White | 8 | 8.15 | Yes | Viscous, gooey residue |
| 4 | NR Black | 12 | 7.73 | Yes | Soft, creamy residue |
| 5 | NR White | 12 | 8.53 | Yes | Viscous, gooey residue |
| 6 | NR Black | 4 | 7.65 | Yes | Soft, creamy residue |
| 7 | NR White | 4 | 7.40 | — | Residue adhered to wall |
| | | | | | of container above water |
| | | | | | line; incomplete |
| | | | | | degradation; was |
| | | | | | gummy and elastic. |
| 8 | NR White | 12 | 8.23 | No | Viscous, gooey residue; |
| | (weighted) | | | | weight broke free while |
| | | | | | the residue floated to the |
| | | | | | surface |
| 9 | NR White | 24 | — | — | Autoclave leakage; |
| | (weighted) | | | | complete water loss; |
| | | | | | residue gooey and |
| | | | | | viscous, Net weight |
| | | | | | loss: 6.40% |
| 10 | NR Black | 24 | 7.16 | No | Soft, creamy residue |
| 11 | NR Black | 12 | — | — | Autoclave leakage; |
| | | | | | complete water loss; |
| | | | | | Residue viscous and |
| | | | | | gooey, Net weight loss: |
| | | | | | 3.74% |
| 12 | NR Black | 12 | 6.74 | No | Soft, creamy residue |
| 13 | NR White | 24 | 7.67 | No | Viscous, gooey residue |
| | (weighted) | | | | |
| 14 | NR White | 4 | 7.00 | No | Sample remained |
| | (weighted) | | | | submerged, but |
| | | | | | degradation was |
| | | | | | incomplete |

Generally, it was found that all three materials, Ester PUR, Black Natural Rubber, and White Natural Rubber can provide a viable alternative to EPDM from a design and seismic standpoint under the desired conditions. Extended testing and higher temperature testing revealed an existence of the ‘tipping point’ for Ester PUR samples between 170° F. and 180° F., and given the lack of margin it was found not feasible to accept the Ester PUR for use at temperatures above 160° F.

### Example 2: Irradiation Testing

The acceptability of polyurethane product materials (e.g., a polyurethane ester composition as disclosed herein) as a replacement to EPDM rubber was evaluated on the materials' resilience to irradiation. The materials underwent two different radiation levels, including 0.84 Mrad representing the dose incurred while installed at the jet pumps during a first refueling outage and 315 Mrad representing the dose incurred should a seal become detached and trapped in a fuel filter for 12 hours during start up. It was observed that the material samples that underwent 0.84 Mrad exhibited minimal changes while the samples that underwent 315 Mrad had completely broken down. Three different durometer levels of the polyurethane material were irradiated and there were no significant trends at differing durometer levels, eliminating the concern of different radiation effects at various durometer levels. The 0.84 Mrad samples then underwent further testing to demonstrate the materials properties after undergoing irradiation. The 315 Mrad samples were unable to undergo further testing due to the complete breakdown of the samples. The further testing included chemical and mechanical testing, which demonstrated that the materials properties were unaffected by the radiation. For verification, the results from the evaluation and irradiation were checked against the GE BWR Operator's Manual for Materials and Processes. The manual specified the damage threshold for Polyurethane to be 4E7 Rads (40 Mrad), which confirmed the validity of the results, more specifically that the material exhibited no damage at 0.84 Mrad (less than 40 Mrad) but had completely broken down at 315 Mrad (greater than 40 Mrad).

For further verification, doses at the Jet Pump Nozzle location were researched, and dose rate surveys at the Jet Pump nozzles were reviewed. It was found that the doses varied between 3,000 and 7,000 Rad/hr on contact. From this data, 10,000 Rad/hr can be conservatively assumed. The duration of a second refueling outage was 37 days, and the Jet Pump Plugs were installed all 37 days. For conservatism, it was assumed that the dose rates at the Jet Pump Nozzle will remain constant throughout the second refueling outage. This is a conservative assumption as the dose rates are reduced as fuel is offloaded, by the Chemical Decontamination of the Reactor Recirculation system, and by other dose reduction initiatives taking place throughout the second refueling outage. At 10,000 Rads/hr for 37 days, the Jet Pump Plugs underwent approximately 8.88 Mrad, leaving a significant margin between the calculated in-use dose and the damage threshold of 40 Mrad.

Due to EPDM rubber and the polyurethane products materials being perceived to be very similar, evaluations were performed in lieu of re-performing the irradiation on the EPDM rubber. FTIR analyses (Fourier Transform Infrared Spectroscopy) were used to determine the similarities of the two materials. The results confirmed that the materials were nearly identical, both materials being TDI (Toluene Diisocyanate) Polyester cured with a Trifunctional Polyol with Benzoflex as plasticizers. With the results from the FTIRs, temperature tests, mechanical tests, and irradiation, the effects of radiation on EPDM rubber were evaluated. It was determined that the polyurethane product materials and EPDM rubber have the same effects due to radiation, which is no effect below 40 Mrad and degradation above 40 Mrad. It was also determined that the thermal effects outweigh the radiation effects, meaning that should a seal become detached, it will melt regardless of the dose incurred.

### Example 3: Performance Testing Under Operating Conditions

Leakage rate was evaluated under normal operating conditions for jet pumps having jet pump plugs as disclosed herein. The leakage rate was determined to be less than 40 gpm in both loops of the reactor. This amount is significantly less than that associated with jet pumps having conventional plugs. The leakage rate was sufficiently low that the valve body was dry enough to permit inspection of the seats. Installation and removal processes were completed in significantly less time than with conventional plugs.

### Exemplary Aspects

In view of the described devices, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A plug comprising: a plug body defining a central bore and comprising a polyurethane ester; and a washer embedded within and bonded to the plug body, wherein the washer has a central opening, wherein the central opening of the washer cooperates with the central bore of the plug body to define a passageway extending through the plug, wherein the passageway is configured to receive a fastener.

Aspect 2: The plug of aspect 1, wherein the plug body is configured to melt or break apart at any temperature ranging from about 267° F. to about 500° F.

Aspect 3: The plug of aspect 2, wherein the plug body is not configured to reform after melting or breaking apart.

Aspect 4: The plug of any one of the preceding aspects, wherein the washer comprises a stainless steel plate.

Aspect 5: The plug of any one of the preceding aspects, wherein the washer defines a plurality of outer openings that are radially spaced from the central opening, and wherein the plug body is cured in a position in which portions of the plug body extend through each of the outer openings of the washer.

Aspect 6: The plug of aspect 5, wherein the washer has a thickness ranging from about 0.005 inches to about 0.015 inches.

Aspect 7: The plug of aspect 5, wherein the washer has a thickness of about 0.01 inches.

Aspect 8: The plug of aspect 5, wherein the washer has an outer diameter ranging from about 1 inch to about 1.30 inches.

Aspect 9: The plug of aspect 5, wherein the washer has an outer diameter ranging from about 1.1 inches to about 1.3 inches, and an inner diameter ranging from about 0.6 inches to about 0.9 inches, wherein the inner diameter defines the central opening.

Aspect 10: The plug of aspect 9, wherein each outer opening of the plurality of outer openings of the washer has a diameter ranging from about 0.1 inches to about 0.2 inches.

Aspect 11: The plug of aspect 5, wherein the washer has an outer diameter ranging from about 1.05 inches to about 1.2 inches, and wherein the central opening has a diameter ranging from about 0.15 inches to about 0.25 inches.

Aspect 12: The plug of aspect 11, wherein each outer opening of the plurality of outer openings of the washer has a diameter ranging from about 0.15 inches to about 0.25 inches.

Aspect 13: A method of forming a seal with a plurality of nozzles of a jet pump, comprising: positioning a plurality of plugs of any one of the preceding claims in alignment with the plurality of nozzles of the jet pump, wherein each plug is positioned in alignment with a respective nozzle; and securing each plug to a respective nozzle to form a seal over the nozzle.

Aspect 14: The method of aspect 13, wherein the jet pump is positioned within a boiling water reactor.

Aspect 15: The method of aspect 14, wherein the boiling water reactor is a nuclear reactor.

Aspect 16: A method of making a plug of any one of aspects 1-12, the method comprising: positioning the washer within a mold; positioning a liquid material comprising a polyurethane ester within the mold; and curing the liquid material to form the plug body with the embedded washer.

Aspect 17: The method of aspect 16, wherein the washer defines a plurality of outer openings that are radially spaced from the central opening, and wherein the plug body is cured in a position in which portions of the plug body extend through each of the outer openings of the washer.

Aspect 18: The method of aspect 17, wherein the washer has an outer diameter that is less than the inner diameter of the mold to allow the liquid material to flow around the outer diameter of the washer.

Aspect 19: The method of aspect 16 or aspect 17, wherein the mold comprises a center projection and a circumferential receptacle that surrounds the center projection, and wherein the washer is positioned over a portion of the center projection and rests within the circumferential receptacle until the liquid material is delivered to the circumferential receptacle.

Aspect 20: The method of aspect 19, wherein the mold comprises a first portion and a second portion that define respective upper and lower portions of the mold and are positioned in alignment to cooperatively form the mold, and wherein at least one of the first portion and the second portion of the mold defines the center projection that supports the washer, and wherein the first portion and the second portion of the mold define a portion of the circumferential receptacle.

All publications and patent applications mentioned in the specification are indicative of the level of those skilled in the art to which this invention pertains. All publications and patent applications are herein incorporated by reference to the same extent as if each individual publication or patent application was specifically and individually indicated to be incorporated by reference.

Although the foregoing invention has been described in some detail by way of illustration and example for purposes of clarity of understanding, certain changes and modifications may be practiced within the scope of the appended claims.

What is claimed is:

1. A plug comprising:
a plug body defining a central bore and comprising a polyurethane ester; and
a washer embedded within and bonded to the plug body, wherein the washer has a central opening,
wherein the central opening of the washer cooperates with the central bore of the plug body to define a passageway extending through the plug,
wherein the passageway is configured to receive a fastener.

2. The plug of claim 1, wherein the plug body is configured to melt or break apart at any temperature ranging from about 267° F. to about 500° F.

3. The plug of claim 2, wherein the plug body is not configured to reform after melting or breaking apart.

4. The plug of claim 1, wherein the washer comprises a stainless steel plate.

5. The plug of claim 1, wherein the washer defines a plurality of outer openings that are radially spaced from the central opening, and wherein the plug body is cured in a position in which portions of the plug body extend through each of the outer openings of the washer.

6. The plug of claim 5, wherein the washer has a thickness ranging from about 0.005 inches to about 0.015 inches.

7. The plug of claim 5, wherein the washer has a thickness of about 0.01 inches.

8. The plug of claim 5, wherein the washer has an outer diameter ranging from about 1 inch to about 1.30 inches.

9. The plug of claim 5, wherein the washer has an outer diameter ranging from about 1.1 inches to about 1.3 inches, and an inner diameter ranging from about 0.6 inches to about 0.9 inches, wherein the inner diameter defines the central opening.

10. The plug of claim 9, wherein each outer opening of the plurality of outer openings of the washer has a diameter ranging from about 0.1 inches to about 0.2 inches.

11. The plug of claim 5, wherein the washer has an outer diameter ranging from about 1.05 inches to about 1.2 inches, and wherein the central opening has a diameter ranging from about 0.15 inches to about 0.25 inches.

12. The plug of claim 11, wherein each outer opening of the plurality of outer openings of the washer has a diameter ranging from about 0.15 inches to about 0.25 inches.

13. A method of forming a seal with a plurality of nozzles of a jet pump, comprising:
positioning a plurality of plugs in alignment with the plurality of nozzles of the jet pump, wherein each plug is positioned in alignment with a respective nozzle, each plug of the plurality of plugs comprising:
a plug body defining a central bore and comprising a polyurethane ester, and
a washer embedded within and bonded to the plug body, wherein the washer has a central opening, wherein the central opening of the washer cooperates with the central bore of the plug body to define a passageway extending through the plug, and wherein the passageway is configured to receive a fastener; and
securing each plug to a respective nozzle to form a seal over the nozzle.

14. The method of claim 13, wherein the jet pump is positioned within a boiling water reactor.

15. The method of claim 14, wherein the boiling water reactor is a nuclear reactor.

16. A method of making a plug, the method comprising:
positioning a washer within a mold;
positioning a liquid material comprising a polyurethane ester within the mold; and
curing the liquid material to form a plug body, the plug body defining a central bore with the washer embedded within and bonded to the plug body, wherein the washer has a central opening, wherein the central opening of the washer cooperates with the central bore of the plug body to define a passageway extending through the plug, and wherein the passageway is configured to receive a fastener.

17. The method of claim 16, wherein the washer defines a plurality of outer openings that are radially spaced from the central opening, and wherein the plug body is cured in a position in which portions of the plug body extend through each of the outer openings of the washer.

18. The method of claim 17, wherein the washer has an outer diameter that is less than the inner diameter of the mold to allow the liquid material to flow around the outer diameter of the washer.

19. The method of claim 16, wherein the mold comprises a center projection and a circumferential receptacle that surrounds the center projection, and wherein the washer is positioned over a portion of the center projection and rests within the circumferential receptacle until the liquid material is delivered to the circumferential receptacle.

20. The method of claim 19, wherein the mold comprises a first portion and a second portion that define respective upper and lower portions of the mold and are positioned in alignment to cooperatively form the mold, and wherein at least one of the first portion and the second portion of the mold defines the center projection that supports the washer, and wherein the first portion and the second portion of the mold define a portion of the circumferential receptacle.
